(19) United States
(12) Patent Application Publication
(10) Pub. No.: US 2011/0272034 A1
(43) Pub. Date: Nov. 10, 2011

(54) Method and apparatus to utilize wind energy within a structure

(76) Inventor: James Patrick Fex, JR., Gulf Breeze, FL (US)

(21) Appl. No.: 13/135,239

(22) Filed: Jun. 28, 2011

Related U.S. Application Data
(63) Continuation-in-part of application No. 12/799,577, filed on Apr. 26, 2010, now abandoned.
Application No. 12/799,577 is a continuation-in-part of application No. 11/401,566, filed on Apr. 11, 2006, now abandoned.

(51) Int. Cl. F03B 11/00; E04H 14/00

(52) U.S. Cl. 137/1; 52/173.1; 137/561 R

(57) ABSTRACT

Method and apparatus for utilizing wind energy within a structure with at least one external surface and at least one internal surface within an internal area that has at least one external surface separating said internal area from an outside that employ various channels to operate any wind powered device and/or any machine device connected with this wind powered device. This method and apparatus also includes structures built as single pressure vessels where the internal areas can communicate and operate at uniform pressures to withstand substantially higher wind pressure challenges; than structures with internal areas that do not communicate. Further structure protection to high winds is accomplished by adding pressure relief valves at the vessel's external surface to relieve wind pressures from within the structure. This is the first use of this readily available, free, unlimited, uninterruptable wind pressure energy within structures.

This application is a continuation in part of parent Ser. No. 11/401,566, filed on Apr. 11, 2006 and continuation in part Ser. No. 12/799,577 filed on Apr. 26, 2010 and applicant claims priority based on the initial Apr. 11, 2006 filing, in compliance with 37 CFR 1.78. Applicant is the first inventor to conceive and produce a working prototype of a method and apparatus to utilize wind energy within a structure by capturing, channeling, concentrating and/or harnessing said wind energy to operate any number, type, form, size and/or shape of wind powered device including but not limited to; pressure transfer openings and/or pressure relief valves and/or any applicable type, form, size or shape of wind powered electrical generator within specially designed wind energy structures with an internal area with at least one external surface separating this internal area from an outside. Additionally, any wind powered device within said wind energy structure can be connected through belts, drive shafts and the like, with machine devices mounted inside and/or outside of this structure, thereby supplying them with energy. These machine devices inside and/or outside of the wind energy structures could be electrical generators, or any other type, size or form of machine devices that could utilize the force, motion and/or energy generated by wind power within said structure, in any number of ways imaginable. Through the implementation of multiple channels within these wind energy structures, any number of wind powered devices and/or machine devices imaginable can be employed. Thus these wind energy structures can be employed to produce low cost, green wind power that can be used in any way imaginable either within these structures and/or by machine devices connected with them yet mounted outside of the structure. To be clear; all of the power utilized will be derived from wind energy generated within these wind energy structures. All previous attempts have only looked outside of structures to utilize wind energy to power their wind devices.

### FIELD OF THE INVENTION

This method and apparatus also includes structures built to withstand strong, high wind challenges. In particular, structure with at least one external surface and at least one internal surface within an internal area that has at least one external surface separating this internal area from an outside. These internal areas will be constructed as single pressure vessels with sealed external surfaces, where channels are established allowing all of the rooms, cavities, floors, plus any and all other internal areas within the structure to communicate. Captured wind pressure energy will be harnessed within the structure through the use of pressure transfer openings and/or pressure relief valves installed on various external and internal surfaces. The prior art only applied their controlled openings to various external surfaces of the structure and not to any internal surfaces within the structure. Additionally, all prior art employed the standard method of constructing structures as multiple pressure vessels, where almost none of the rooms, cavities, spaces and/or floors within the structure, could communicate with each other; leaving them prone to destruction from high winds. This method and apparatus will produce a single, strong pressure vessel that will operate at a uniform pressure and withstand substantially stronger winds and increased dynamic wind pressure challenges, than multiple pressure vessel structures. Further resistance to high winds can be accomplished by establishing a channel to outside at the external surface of all internal areas and harnessing captured wind pressure within the structure to operate weather resistant pressure transfer openings and/or weather resistant pressure relief valves in these channels. This will relieve wind induced pressure buildups within said structures, to an outside, as they occur during these strong wind and/or pressure challenges; before these captured pressures can become so concentrated as to cause catastrophic structure failure. Previous attempts have failed to detect this captured dynamic wind pressure within the structure and the free energy it provided. Therefore, they mistakenly used control theory systems involving electrical power, data processors, controllers, controlled openings, pressure transducers, static pressure theory and/or sensors to protect structures from high wind challenges. Their controlled openings are not self regulating, nor are they automatic as taught by the patent application at hand. They are totally, externally influenced and/or assisted by their pressure sensors, pressure transducers, controllers, data processors, even when operated manually, which is just another form of external influence. Disconnect their openings from electrical power and/or their pressure sensors, pressure transducers, controllers and/or data processors and these openings will never operate properly, if at all. Since the applicant's scheme harnesses this uninterruptable and unlimited captured wind energy within the structure to operate all of his pressure transfer openings and/or pressure relief valves; they do not suffer from any of these prior art limitations.

### BACKGROUND OF THE INVENTION

The design of structures in hurricane zones, tornado alleys and other high wind prone areas is a complicated and difficult issue that has undergone much study and scrutiny over the years. The events of the past several years and months have further heightened this research. Construction designs that are resistant to strong, high velocity winds and the dramatic pressure fluctuations and differentials they cause; are not only difficult to accomplish, but exceedingly difficult to accomplish, when guided by prior art assumptions. Assumptions concerning the design of structures have been determined by this applicant to be, by and large, inaccurate, if not totally incorrect. One of the tasks of structure architects, designers, developers, contractors, owners, building codes and/or others is to construct structures that can survive high wind challenges. For the past 100+ years, building construction has involved the construction of an enclosed living and/or working area that is usually sealed as well as possible to all surrounding environments including the attic (one pressure vessel), and a separate attic area that is allowed to leak to all surrounding areas except the enclosed living and/or working area (creating another, separate, leaky, pressure vessel). Plus, sealed floor cavities, sealed roof cavities, sealed ceiling cavities, along with sealed external and internal wall cavities (creating even more, individual and totally separate, pressure vessels). For a description of “sealed”, I refer to Webster's; “to close or make secure against access, leakage, or passage by a fastening or coating”, and further by “to fix in position or close breaks in with a filling (as a plaster)”.

These prevalent mistakes have resulted in individual structures that incorporate multiple, yet totally separate and individual, pressure vessels, with shared vessel walls that end up working against one another and weakening all of the areas involved, which in turn weakens the entire structure. This common error in design has in turn lead to the premature failure of structures during hurricanes, tornadoes and even excessive straight-line winds. Through his extensive research into structure pressures involved in the applicant's three granted U.S. Pat. Nos. 6,584,855; 6,968,745 and 7,127,850; the applicant has discovered that these uncontrolled, multiple, separate and individual pressure vessels existing next to each other, while sharing some vessel walls; generates a series of structure failure points during strong winds and dramatic pressure challenges.

Winds result from atmospheric pressure differentials. High winds result from deep atmospheric pressure differentials. As these atmospheric pressure differentials pass over or even near these multiple pressure vessel structures, the pressure differences generated between these individual and totally separate, pressure vessels within the structure, such as the enclosed, sealed, living and/or working area, the leaky attic area, the sealed roof cavities, the sealed interstitial areas, sealed floor cavities, sealed roof cavities and sealed wall cavities, etc. . . . , that share common vessel walls, dramatically increase and can lead to the premature failure of said structures. It is these uncontrolled pressure differences, between these connected but totally separate and individual pressure vessels, some with shared walls, working against one another, that can literally pull, compress, tear and blow a structure apart during high wind events.

Applicant's thirty years of research in the field of structure pressure has taught him many things. One is that air moves into a standard structure on the wind impact wall, as air moves out of the other three walls. Even when the wind impacts the walls of a standard structure in a glancing blow, the net effect is roughly the same; approximately 75% of the external wall surfaces are under a negative pressure effect generated by the wind; which pulls air out of the structure. The remaining approximately 25% of the external wall surfaces are operating under a positive pressure effect generated as the wind impacts these areas, resulting in air being pushed into the structure. This results in an ever increasing negative pressure effect on roughly 75% of the skin, or external surface, of a standard structure. As the wind increases, structures begin to reside at an ever increasing negative pressure. Applicant originally thought that this phenomenon continued forever and that structure pressures just grew ever more negative and is the primary idea that he based his original three patents on. Through his continued research, applicant discovered something very interesting; that at somewhere between 60 and 70 mph winds, this phenomenon reverses. The stronger winds on the approximately 25% positive pressure impact wall begin to push much more air into a standard structure than can be pulled out of the remaining roughly 75% negative pressure walls and the structure begins to operate at an ever increasing positive pressure.

In 1684 Blaise Pascal wrote the primary rule of pressure, known as Pascal's Law: “a change in the pressure of an enclosed incompressible fluid is conveyed undiminished to to every part of the fluid and to the surfaces of its container”. In the case at hand, air is the fluid and it can be considered incompressible. All of the structure's wall cavities, floor cavities, ceiling cavities, roof cavities and other cavities are sealed with plaster, so they each operate as standalone pressure vessels/containers. For a definition of “vessel” I turn to a Webster's dictionary: “a container for holding something”, the “something” in our case is the pressure generated by the effects of wind on the skin/surface of the structure. Pascal's Law can also be interpreted as: “the pressure at any point in the contained fluid field is the same as at any other point in the contained fluid field”. Based on this information, the patent application at hand defines “single pressure vessel” as “any internal area and/or space within a structure where the pressure within the contained fluid field resides at equilibrium, that changes uniformly as any changes in pressure are applied at any point in the fluid field, thereby equalizing, and any pressure change is also immediately conveyed undiminished to the surfaces of its container/structure”. Webster's defines “equilibrium” as “a state of balance between opposing forces or actions that is either static or dynamic”. Webster's defines “equalize” as “make equal, uniform”. While defining “uniform” as “(1) always equal; (2) non differentiated”. For this invention, these words mean/describe the same thing and are interchangeable, and refer to “any attempt, method, scheme, occurrence and/or apparatus that allows pressure and/or air to equalize to a uniform equilibrium within the structure and/or single pressure vessel”.

Applicant began to closely study the effects of this Law on a standard structure during a high wind event. He quickly determined that the dramatic low pressures outside and strong winds flowing over roofs during a strong storm are insufficient on their own to pull a single roof from a single structure, so he turned his attention to the energy these low pressures and winds generate, within the structure. Wikipedia describe “wind” as “the flow of gases on a large scale” and goes onto say “air is accelerated from higher to lower pressures”; so “pressure energy” is the root force of “wind energy” and is why air will only move from all higher pressure areas towards these low pressure storm areas, based on Pascal's teachings and Bernoulli's “dynamic pressure” equation: “the square root of this pressure differential; times the constant 4005; equals the velocity of this movement of air in feet per minute”, thereby generating “wind energy”. Air is just the fluid, the important information is the “dynamic pressure energy” imparted on it, as represented by Bernoulli's velocity/dynamic pressure formula stated above. Air, plus this energy, is what we call wind. Applicant could not find a definition of “wind energy” and must assume that its very name describes itself. For the patent application at hand “wind energy” will be used to describe “any energy, motion and/or force derived from wind, including pressure from wind, dynamic pressure, dynamic pressure energy, dynamic wind pressure, dynamic wind pressure energy, wind pressure energy and/or any version thereof, regardless of how it is used”. To separate this invention from all prior art; “wind energy” as used in this application does not include and/or involve any use of wind as a thermal transport medium to cool and/or remove heat and/or provide fresh air; to a structure, from a structure and/or within a structure.

Wikipedia describes “wind power” as “the conversion of wind energy into a useful form of energy” and “dynamic pressure” as “being closely related to the kinetic energy of a fluid particle” and “the pressure of a fluid particle in motion”, again the fluid particle in our case is air, therefore in the patent at hand, “dynamic pressure”, “dynamic pressure energy”, “dynamic wind pressure”, “dynamic wind pressure energy”, “wind pressure energy”, “wind pressure energy”, “pressure from wind”, “wind”, “wind energy” and/or any version thereof, describe the same force, motion and/or energy and can be used interchangeably. Dictionary.com describes “device” as “a plan or scheme for effecting a purpose”, so in this invention “wind powered device”, refers to “any attempt, scheme, strategy, occurrence, method and/or apparatus to purposefully use wind energy to operate any device and/or machine imaginable, regardless of the output”. Webster's defines “machine” as an assemblage of parts that transmit force, motion and/or energy one to another in a predetermined manner”. For the patent application at hand “machine device”, refers to “any attempt, strategy, scheme, occurrence, method and/or apparatus to purposefully connect any imaginable machine and/or device with a wind powered device and thereby transmit any and/or all of the force, motion and/or energy generated by said wind powered device to said machine and/or device and utilize it to operate said machine and/or device in any way imaginable, regardless of the output”. The aforementioned “pressure relief valve” is one example of a wind powered device, and is so important throughout this patent that it will only be referred to as its primary intended purpose “pressure relief valve”. Therefore to avoid confusion, the term “wind powered device” is primarily used to describe every other type of wind powered machine and/or device as described above.

The definition of the primary terms used to describe this invention need to be established. Webster's defines “utilize” as “to make use of: turn to practical use”; “capture” as “to take captive”; “channel” is defined as “a means of communicating”; “concentrate” is “to accumulate”: and “harness” is defined as “to tie together”. So for our purposes here “to utilize wind energy within a structure” refers “to any and/or all attempts, schemes, occurrences, methods, strategies and/or apparatuses that use any form and/or type of wind energy whatsoever within a structure”. “Capture/captured/capturing” refers to “any and all attempts, schemes, occurrences, methods, strategies and/or apparatuses whereby wind energy becomes captive within a structure”. “Channel/channeled/channeling” refers to “any and all attempts, schemes, occurrences, methods, strategies and/or apparatuses for allowing this captured wind energy within the structure to communicate with any and/or all areas within the structure and/or an outside”. “Concentrate/concentrated/concentrating” refers to “any and all attempts, schemes, occurrences, methods, strategies and/or apparatuses for accumulating wind energy within a structure”. “Harness/harnessed/harnessing” refers to “any and all attempts, schemes, occurrences, methods, strategies and/or apparatuses to tie together any and/or all of the above in any conceivable way to use this wind energy within a structure, in any conceivable way”.

Velocity/dynamic pressure is the high velocity wind energy that impacts the walls of a standard structure during a high wind event and as it enters a standard structure through minute leaks its skin/surface, it becomes a captured dynamic pressure as it changes dramatically over short periods of time, within the structure. For this invention, “leak/leaking/infiltrate” are interchangeable and refer to “wind energy entering the structure and/or single pressure vessel by mistake and/or in any unplanned way”. This trapped/captured dynamic pressure will quickly begin to tear apart the structure's external to wall cavities, floor cavities, ceiling cavities, roof cavities and other cavities within multiple pressure vessel structures. This can be avoided if the structure is constructed as a single pressure vessel as taught by this patent, because only then can this captured dynamic pressure be channeled quickly and undiminished to all of the external surfaces of the structure/container's internal areas. Here, this captured dynamic pressure can be utilized to actually strengthen these same surfaces against strong impact winds, by exerting an approximately equal counter force on these same areas, according to Newton's Third Law: “to every action there is an equal and opposite reaction”. Sealed external wall, floor, ceiling, roof and other cavities will prevent it. This is why the structure must become a single pressure vessel operating at a uniform pressure, so that all captured pressure changes will be immediately channeled undiminished to all of its surfaces, as it strives to reach equilibrium within the structure, with any excess pressures channeled to outside, preventing structure failure.

Pascal and Bernoulli agree that “velocity pressure” and “dynamic pressure” are the same force, and as stated above is “the pressure of a fluid particle in motion”; so to measure them, one must measure the movement of air. “Static pressure” is defined as “the pressure of a fluid particle that is not moving”. Therefore, static pressure sensors and/or pressure transducers cannot measure the pressure of moving air, so they will never accurately measure velocity/dynamic pressures, nor could they ever measure them quickly enough. All before this applicant have attempted to determine the differential pressure of a standard structure during a storm, and even during normal wind conditions, using pressure transducers, static pressure sensors and/or theory, therefore they have always failed. Since static pressure sensors and/or pressure transducers must be deployed directly into the fluid field, where they must wait until the structure begins to actually inflate, before pressure is imposed on a static pressure sensor. By then the damage to the structure will have already occurred. A much faster scheme was needed to accurately and quickly measure structure pressure and applicant's first two granted patents directly addressed this particular issue by employing Pascal's Law and measuring the dynamic pressure of a structure/container directly at its surface/skin by measuring the velocity of air as it enters and leaves the structure. This method is much faster and far more accurate to and was never used by the prior art. Only this applicant has put it to practical use.

The patent application at hand is also based on dynamic pressure in the form of wind energy as it becomes captured within a structure during a high wind event and how to actually concentrate and/or harness this captured energy to save the structure by using it to operate pressure transfer openings and/or pressure relief valves to establish communication channels; while also strengthening the impact walls and/or producing electrical power. When applicant stood below his roof mounted skylight and saw it pop open every few seconds, and even faster as the winds strengthened during IVAN and felt the dramatic rush of air by him on its way out of his home, he instantly knew his research and math was right and that he had discovered something new, important and very powerful. Applicant soon realized that the energy within this captured dynamic wind pressure could easily be channeled, into one or more channels within a structure; then concentrated and/or harnessed to operate any form, type and/or size of wind powered device, including any form, type, shape and/or size of wind powered electrical generator. These wind powered devices can also be connected with any form, type and/or size of machine device including but not limited to electrical power generators; whereby the force, motion and/or energy from these wind powered devices is transmitted to said machine device. Either way, large amounts of mechanical power can be generated with a properly designed wind energy structure, in winds as low as 1.0 mph, and much, much more during high velocity winds including hurricanes and/or tornados.

How do these destructive dynamic pressures become captured within a structure? During high wind events, approximately 25% of a structure's external cavities on the wind impact side of a standard structure begin to inflate to an ever increasing positive pressure as wind energy enters through leaks. External wall cavities, roof cavities, floor cavities, ceiling cavities and/or any interstitial areas, refer to any wall cavity, roof cavity, floor cavity, ceiling cavity and/or any interstitial area that has an outside on one side of the wall cavity, roof cavity, floor cavity, ceiling cavity and/or any interstitial area and the enclosed internal area within the single pressure vessel, on the other side of the wall cavity, roof cavity, floor cavity, ceiling cavity and/or any interstitial area. This increased positive pressure is transmitted undiminished to all of the surfaces of these external cavities. This can cause these sealed external cavities to actually inflate and expand before the air can further leak into the structure core. For a description of “core” applicant turned to Webster's: “the center of an object”. Therefore, in the patent application at hand, the term “structure core”; “includes all of the internal areas of the single pressure vessel, which are located within the structure”. This expansion can weaken everything connected to these external cavities such as windows, doors, roofs, etc. . . . It can progress to the point that windows, doors and roofs are actually blown out of the structure. Unchecked, applicant asserts this dynamic wind pressure can quickly grow to the point in these external cavities and the structure core where they contain enough captured energy to easily push windows and doors out of the actual impact wall of a structure, directly against 100+ mph winds. Therefore, wall openings as employed and taught by previous patents, could eventually be prevented from opening when needed, or blown open, by this dynamic pressure; leading to the assured destruction of the structure.

The deflation of the approximately 75% of a structure's external wall cavities on the other sides of a standard structure is also conveyed undiminished throughout external structure cavities and can easily progress to the same point where windows, doors and roof connections within these cavities are weakened. Whether deflating or inflating, the result is the same, over time and many, many storms, or just one strong storm, all connections in and to these external structure cavities are weakened, including roof tie downs. The negative pressure external cavity during one storm may be the positive pressure impact cavity during the next storm, or even later during the same storm. The inner core of the structure is another totally separate pressure vessel, from the individual external cavity pressure vessels. One of the purposes of this invention is to address this situation by establishing channels that allow all external cavities to easily, communicate with the inner core of the structure, establishing a much larger single pressure vessel that can easily withstand much higher pressures and thereby eliminate the opportunity of these multiple vessels with shared vessel walls, from working against each other and eventually tearing and blowing each other, and eventually the entire structure, apart.

These external cavity pressures are slowly transmitted directly to the core of the structure through the shared vessel walls. Once the structure core begins to experience the ever increasing positive pressure, it will also weaken as it inflates. Other internal cavities of the structure such as but not limited to floor cavities, ceiling cavities, wall cavities, attic cavities and/or other interstitial cavities will now operate as even more totally separate pressure vessels that reside at different pressures than the structure core and its external cavities. Internal wall cavities, floor cavities, ceiling cavities and/or any interstitial areas, refer to any wall cavity, floor cavity, ceiling cavity and/or any other interstitial area that has enclosed, internal areas within the single pressure vessel, on both sides of the wall cavity, floor cavity, ceiling cavity and/or any interstitial area. Over time the ever increasing pressure differentials between all of these totally separate pressure vessels with shared vessel walls, within the structure, begin to tear and pull against one another, further weakening the entire structure.

Applicant's research teaches him that this ever increasing captured internal positive structure core pressure eventually concentrates to the point where it blows roof membranes and sometimes entire roofs, off of a structure. Many before applicant have asserted that the increased relative air flow parallel to the top surface of the roof and/or wind under roof eves during a storm, generates a sufficient low pressure over said roof surface to generate a sufficient upwards force, to lift the roof from a standard structure. Applicant says they have never truly understood the real problem, so they have failed every time they tried to solve it. Several years ago, many building codes doubled the number of roof tie downs to solve roof lift. This attempt at an improvement failed to produce noticeable results. If one does not know the real problem, then they can never solve it and they are doomed to only treat the symptoms of the real problem. The real problem is run away positive structure internal pressure that eventually becomes so concentrated that it blows the roof off of the structure, or blows the entire structure to pieces. In high rise structures this run away positive structure pressure on the individual floors blows windows and walls out.

Applicant ran many aerodynamic calculations based on Newton's Laws of Motion and Bernoulli's work, and hereby declares that he never came across a single formula or solution that would generate a sufficient lift to pull a single roof from a single structure it is attached too, even before he added the additional drag forces of the roof tie downs. Applicant would love to see someone prove him wrong, so he can learn something new. Both flat and sloped roofs failed to provide the smooth, streamlined air flow pattern required to provide a sufficient aerodynamic lifting force, especially when dormers, chimneys, roof vents, etc., were added to the calculations. It must be remembered that sloped roofs and especially flat roofs, generate high Reynolds Numbers over their surfaces as the air moves up walls and over the roof. Turbulence always denies lift.

It is applicant's opinion after running many of these calculations, his 30 years of structure pressure work and through his 32 years of hurricane observation, that the predominant component of the aerodynamic force that occurs in the fluid flow up to approximately 60 mph, relative to approximately 50% of a standard structure that have winds flowing along them; is manifested as a “drag force” that acts parallel relative to the flow. This explains the ability of this flow to pull air out of approximately 50% of the structure's external surfaces that have winds flowing along them, up to approximately 60 mph. Then when the fluid flow along these same sides of a standard structure exceeds approximately 60 mph, the predominant component of the aerodynamic force is manifested as a “lifting force”, which acts perpendicular relative to the flow. This explains why the ability of this flow to pull air out of approximately 50% of the structure's external surfaces is dramatically reduced during high strong winds. The approximately 25% of a standard structure that is truly downwind, does continue to encounter a negative pressure effect that pulls air from a standard structure, regardless of wind speed. Applicant hereby declares that he has never seen or heard anyone else explain this phenomenon this way and that he has shared it with no one until now. He spent a lot of his personal funds and productive hours to learn this and use it in the patent application at hand, and on his own home.

And yes, applicant is saying that “a lifting force definitely exists on the roof of a standard structure”, it is just dramatically insufficient to lift a single roof from a standard to structure, even during hurricanes and tornadoes. It failed to lift his operating skylight from his home during hurricane IVAN when only one piece of ½″ bungee and one piece of ½″ rope, tied so it would let the skylight open 10″ were available to keep it from flying away. In other words, the elastic memory of ½″ bungee is all that was needed to keep his skylight closed and prevent it from being torn from his roof. This is positive proof that the 138 MPH winds of IVAN that raced over his roof, were unable to lift even this skylight against the ½″ bungee. It only opened every few seconds to relieve the built up dynamic pressure from within his home and then slam shut, directly against these same roof lift forces. It is still there today, undamaged. These roof lift forces are however quite sufficient to make applicant's same roof mounted pressure relief valves extremely efficient and quick, due to the large pressure differentials that are generated on the roof, in relationship to the captured dynamic pressure within the structure. The perpendicular lifting force along the sides of the structure will render wall mounted openings as used in prior art, inefficient, if not totally inoperative. All before the applicant have failed to understand this important phenomenon, so their attempts at protecting a standard structure during high winds, have totally failed as they only treated the symptoms of the real problem, but never the real problem itself.

Applicant also hereby asserts that the walls of a standard structure experience far stronger impact forces than the roof lift forces, during strong storms due to the well known “Coanda Effect” that teaches “the tendency of fast moving streams of air to deflect towards a nearby surface”, which even increases when the surface is curved, like the Earth. So, even though both hurricanes and tornadoes have cyclonic motions which are governed by Coriolis Effect, the strong high velocity winds they generate will contact structures with an aerodynamic force moving parallel with the Earth's surface and perpendicular to a structure's vertical external walls. Thereby contacting the external walls that face the oncoming winds with the strongest possible “impact force”, before moving over the roofs and generating a far lesser “lifting force”. Bernoulli's equations linked with the mathematics that supports the Coanda Effect, back applicant's assertion. As further proof, applicant offers TV footage of the Springfield, Mass. tornado of Jun. 1, 2011. Film footage from a high rise building on CBS, clearly shows very high velocity straight line winds being drawn into the bottom of the vortex, right at ground level and parallel to the Earth's surface. So, other than within the actual vortex, high velocity, straight line winds moving parallel to the Earth's surface cause most of the structure damage encountered during tornadoes, hurricanes and all high velocity winds.

Other support is found in the pictures on TV; which show walls still standing when roofs are blown off. Plus, the debris fields are always downstream from the structure involved and along the path of the strongest winds. Tornadoes do not just “lift” everything they encounter and carry it away, as some believe. If this were true, then tornado damage zones would be wiped clean of all debris, making starting over a whole lot easier. But this is not true. Yes, the actual vortex center of a tornado can lift objects until the air mass (air plus energy) beneath the object weakens to the point where it becomes less than the mass (weigh corrected for shape) of the object and the object uncontrollably precipitates from the sky. In reality, the objects that are “lifted” any real distance are light. Damage to vehicles usually results from high velocity, straight line, wind getting under them and then flipping and rolling them over and over again, until they may look like they were “lifted” and dropped, but applicant's calculations do not support this theory. Applicant also says that “people” supposedly “sucked” from vehicles are once again severely blown from the vehicle and then severely blown downstream by these same high velocity straight line winds. Cell phone videos taken during the actual tornadoes in Alabama and Missouri always showed dark rooms with no electrical power.

Applicant hereby asserts that most, if not all structures damaged by high winds are “blown” apart as described within this specification and not as previously “believed”. Applicant would love for someone to try to prove him wrong so he can learn something new. Plus, he awaits an explanation of how these walls remained standing, along with how his skylight survived the 138 mph winds that flowed over his roof; with only the ½″ bungee holding it down. His research and mathematics all combine in a coherent theory that simply and completely tells the truth about what is happening. The walls are currently strong enough to withstand strong storm winds and current roof tie down requirements are sufficient to keep the roofs on the structures, provided the wind induced, captured dynamic pressures within the structure's cavities and its core are channeled and allowed to quickly communicate with each other and generate a single pressure vessel and not allowed to become excessively concentrated.

To keep this ever increasing captured positive structure pressure during storms from becoming so concentrated that is destroys a standard structure, a direct channel must be established so that the inner core of the structure can easily communicate with an outside, in an automatic way. Applicant's scheme is the first ever, to utilize this captured pressure within his home/structure to operate his weather resistant pressure relief valve/skylight, which can be set at any desired relief pressure. Presently applicant thinks that the structure should be kept at a slight positive pressure in relationship to outside, allowing Newton's third law to help save the structure. Applicant hereby declares that he has done extensive research on the size requirements of these weather resistant pressure relief valves to outside and all of the other pressure relief openings located on various internal surfaces within the structure, as described in this patent, for single story and multiple story structures and has developed a formula for sizing them.

Applicant has over 14 years of experience selling and commissioning self regulating, automatic, pressure operated, pressure relief dampers, vents, openings and/or valves in the HVAC Industry. Some used springs, some used counter weights and some even used blatters. Applicant spent a lot of time picking the term “pressure relief valve”. At that time he also researched the following phrases “pressure relief damper”; “pressure relief openings” and “pressure relief vent”, and neither Webster's nor Wikipedia had, or currently has, a definition for any of them. Only “pressure relief valve” had and has a definition within Wikipedia. Applicant then used Webster's to obtain the definition for “valve”; “control consisting of a mechanical device for controlling the flow of a fluid”. Air is a fluid. Then applicant obtained the definition of “damper”; “to regulate the volume of air”. Webster's defines “openings” as “an open or empty space in or between things”. “Vent” is defined as “a hole for the escape of gas or air”. Applicant asserts that “valve” is compatible with the definition of a “damper”, “opening” and “vent” based on their definitions and will be used interchangeably within this application.

So for our purposes here “pressure relief valve” includes “any and/or all types and forms of self regulating, automatic, pressure operated, pressure relief dampers, openings, vents and/or valves that allow air to, automatically and/or proportionally move from one space to another, only after, the required/desired relief pressure, has been reached within one of the spaces involved and then closes again when the pressure situation is solved; such as the pressure of the area involved is reduced below a specified maximum set point by operation of the pressure relief valve”. For additional clarity the term “the pressure relief valve once set does not require external influence or assistance” refers to the fact “that all of the pressure relief valves referred to throughout the patent application at hand do not require any external influence and/or any human, electrical, computer, control, sensor, machine, trigger and/or any kind, type and/or form of external assistance to function once their relief pressure has been set”. Additionally, the term “weather resistant pressure relief valve” applies to all pressure relief valves that open to an outside and must be constructed of weather resistant material and in weather resistant dimensions, so they can withstand high winds, salt water and extremely bad weather, for example. To avoid confusion the standard term “pressure relief valve” applies to all pressure relief valves whether they are fully removed from the outside and mounted on internal surfaces or exposed to high winds and bad weather.

On his home, applicant used a variation of the spring type of a self regulating, automatic, pressure operated, weather resistant pressure relief valve, by employing the ½″ piece of bungee cord on his operable skylight. For a description of “pressure relief valve” applicant referred to Wikipedia which defines it as an “automatic system that relives static pressure on a liquid. It specifically opens proportionally with pressure increasing.” This means that all “pressure relief valves” “self regulate proportionally” and are in fact “automatic” and “pressure operated”. Wikipedia goes onto say that “relief valves” are “spring operated”, or “weight loaded”; while pneumatic controlled, motor controlled, solenoid controlled and/or manually controlled openings as used in previous patents, are never mentioned, or included. As stated previously, applicant deployed a self regulating, spring operated, automatic, pressure operated, pressure relief valve on his hone by adapting his operable skylight. In applicant's claims when he refers to pressure relief valves, it is understood they will be blatter and/or spring operated and/or weight loaded, and never motor controlled, pneumatic controlled, solenoid controlled and/or manually controlled. They will be approximately located as shown on the drawings and mounted per the manufactures recommendations, to maintain all warranties.

Pressure relief valves are both pressure operated and blatter and/or spring operated and/or weight loaded, because pressure pushes the valve open when the pressure in the structure exceeds the rating of the blatter, spring and/or weight and then the blatter, spring and/or weight closes the valve again once enough pressure has been relieved/released and the desired structure pressure rating/setting is achieved again. They are also capable of operating proportionally at any point between open and closed to accommodate the amount of pressure encountered. “Pressure operated” had no definition within dictionary.com, Webster's or Wikipedia. Dictionary.com defines “pressure” as “the exertion of force upon a surface by a fluid” and “operated” as “to work, perform, or function”. So, for our application at hand “pressure operated” refers to any “machine, device, damper, vent, opening and/or valve that operates proportionally in a direct reaction to the exertion of force by a fluid upon its surface” Again, in our case at hand, air is the fluid. No electrical power, sensors, controls, control systems and/or information technologies, whatsoever are needed for applicant's dampers, vents, openings and/or valves to operate properly when needed. On this same page in Wikipedia, seven (7) types of “Pressure relief valves” are defined and every one of them is listed as “automatic”. Webster's II New College Dictionary defines “automatic” as (a) “operating in a manner essentially independent of external influence or control” and (b) “self regulating”. Dictionary.com defines “automatic” as “having the capacity of starting, operating, moving, etc., independently, unconsciously”.

Webster's goes on to define “independent” as “not requiring or relying on something else”; and “external” as “situated outside, or apart”; and “influence” as “the power or capacity of causing an effect”; and “control” as “to exercise restraining or directing influence over”; and “self regulating” as “regulating oneself or itself”; and “regulate” as “to adjust the amount, degree or rate of”. For the patent application at hand, “automatic” means “that no controls of any kind, including manual, can be employed if the system is to be accurately considered ‘automatic’, and all openings must be capable of starting, operating and regulating themselves and be considered totally independent of any and/or all external influence, whatsoever; no electrical power, controls, information technologies, triggers and/or control systems of any kind can be used in a truly automatic systems; additionally no form of ‘control theory’ involving any or all of the following: data processors, controllers, controlled openings, pressure sensors, pressure transducers, static pressure theory and/or static pressure sensors, can be used in a truly automatic system”. No other prior art building, high wind, protection scheme complies with all of the above definitions of the applicant's pressure relief valves. Primarily because unlike the applicant, they all failed to observe the unlimited, uninterruptable, free, source of dynamic wind pressure energy that builds up within structures during high winds.

The only prior art involved in any of the claims herein is PARKER (U.S. Pat. No. 5,956,903) and his scheme is based totally on “control theory”. Wikipedia describes “control theory” as “an interdisciplinary branch of engineering and mathematics that deals with the behavior of dynamical systems. The desired output (structure pressure control) of a system is called the reference. When one or more output variables (sensor readings) of a system need to follow a certain reference over time, a controller manipulates the input (controlled openings) to a system to obtain the desired effect on the output of the system.” Wikipedia goes on to show that “controllers, sensors, electronics and pneumatic or electric motors” are always required in “control theory” applications. Webster's defines “dynamical systems” as “systems marked by usually continuous and productive activity or change”; which is how all “control systems” operate, including PARKER's. Applicant was granted U.S. Pat. No. 6,584,855 in July of 2003 after arguing against this exact same PARKER patent, when the Primary Examiner, Mr. Edward Leflcowitz agreed that his use of “dynamic pressure sensors and theory” was far better than PARKER's use of “static pressure sensors and theory”. The following paragraphs describe exactly how different these two theories are. In all of the arguments between 2000-2003 the PARKER patent was always referred to as a “control theory system”, yet now this exact same PARKER patent has somehow magically become an “automatic system”. For the past three years this applicant has repeatedly said that PAKER is not an “automatic system”. In light of this, applicant respectfully asserts that it is unfair and somewhat unjust for the USPTO to use the same patent to disallow applications concerning systems that are the opposites of each other. The original use of PARKER as a “control theory system” make all current references to PARKER as an “automatic system”, moot. Applicant respectfully requests a direct response to this important issue, before continuing this misuse of the PARKER patent to disallow claims of this current invention. Five years is long enough. Due to the examiners remarks concerning PARKER in the immediate previous parent filings, applicant is now forced to spend more valuable time and money to fully address PARKER for the fifth time.

Whenever PARKER references his pressure sensors, pressure transducers, controllers and/or data processors, all of them are mounted “apart/externally” from his “controlled openings” and never installed directly on his openings; leaving all of his openings completely dependent on these remotely mounted items. PARKER does however mount a “sensor” on each of his “openings”, but the sole purpose of this sensor is to “sense the open or closed status of the opening”. These particular “sensors” are not “pressure transducers” nor do they sense pressure, nor could they be used to sense any pressure or control these openings, nor could they ever actually open or close the openings, by themselves. Therefore, all of the controlled openings of the prior art operate only under the “external control” and “external influence” of the “externally” mounted pressure sensors, pressure transducers, controllers and/or data processors; and these devices in turn are not independent themselves because all of them are totally dependent on electrical power to operate and electricity is the ultimate form of “external influence” and usually fails during storms. These open-close sensors mean that even more precious seconds are lost as their information is processed by the controller and/or data processor.

Applicant originally thought that PARKER never used the word “automatic”, but he was wrong. Yet even when PARKER references the word “automatically”, it is a misuse of the word by also referencing the words “when triggered, the latch could open causing the shutters to close automatically (by spring loading)”, which once again refers to an “external influence”. This is just a simple “spring close” operation and not any true form of “self regulation”, or even “regulation” as defined above by Webster's and taught by this applicant. An open-close shutter operation is not a true attempt “to adjust the amount, degree or rate of anything because it would never open again until someone came and manually opened it and reset the latch. Additionally, if PARKER just chose to slap shut all of his openings in this way, the structure would still be destroyed as the ever increasing buildup of dynamic pressure within the structure eventually reaches a point where it blows the structure to bits, as described in this applicant. Proof of this is the use of high quality storm shutters on the home directly next to the applicant's during hurricane WAN. This home suffered over $100,000.00 dollars in wind impact damage, while the applicant's home suffered no wind impact damage.

Plus, the only “triggers” ever referred to by PARKER are defined as either a “pressure transducer” or a “telephone call”, neither of which complies with the patent application at hand's use of “pressure relief valve” as clearly defined above by Wikipedia, Webster's and this applicant. Additionally, the drawings involved with these words by PARKER show no “pressure sensor” or “pressure transducer” mounted on the shutters involved. A true automatic control system never needs a “trigger” nor does it ever need someone to manually do anything to assist in its control, and/or to activate the system itself. Applicant's ideas are the only true automatic, self regulating, high wind, structure protection scheme in existence, requiring that no one do anything to assist in its control and/or to active it. Once set., it is ready to protect the structure 24 hours a day, 365 days a year, even at night or when unoccupied, just waiting for pressures to increase within the structure, to activate its automatic, self regulating, openings. The “control theory” portion of PARKER is never referred to as “automatic”, because PARKER and everyone else, but the USPTO, knows that it is not automatic, nor is it self regulating.

Further, when PARKER does reference “automatic operation” it is another misuse, as he goes on to say “the system is triggered by the pressure transducer”, which once again refers to an external influence”, because per his drawings and specification the “pressure transducer” is always situated “apart/external” from his “openings”. He even goes on to say “an advantage and preferred feature of the invention is that since the invention operates on pressure differentials low-cost pressure sensors can be used”, which is a clear reference to “pressure transducers” to those skilled in the art of pressure control, who also know a “pressure transducer” is only capable of sensing static pressure. They are slow to react to volumetric pressure changes, allowing structure damage to occur before the pressure sensors ever detect it and surely before the data processor and/or controller can react to the pressure sensor information. It is just this type of misinformation and system wide delays that will setup errant pressure waves and bubbles within a structure; which will progress to the point where the protection scheme itself will eventually destroy the very structure it was installed to protect.

Wikipedia defines “pressure” as “an expression of the force required to stop a fluid from expanding”; while “pressure sensor” is defined as “a pressure sensor usually acts as a transducer, it generates a signal as a function of the pressure imposed”. Imposed means it can only be a static pressure sensor and not a dynamic pressure sensor. “Static pressure” and “dynamic pressure” are described in earlier in this specification. Static pressure sensors generate a signal in direct proportion to the amount of pressure imposed on them; while dynamic pressure sensors simply measure the velocity of the air as it moves from a high pressure area to a low pressure area and then employs Bernoulli's equation provide earlier, to quickly convert this velocity into a an extremely accurate dynamic pressure reading. No true pressure whatsoever is ever imposed on a dynamic pressure sensor. In all of the prior art schemes, including PARKER and ASHRAE, a single internal pressure sensor is all that is ever mentioned or shown on any of their drawings. If PARKER had ever wanted to mount his “controlled openings” within a structure; more than one internal static pressure sensor is required, because the data from two separate and individual static pressure sensors must be compared to determine even a single “differential pressure”. With the words “an internal sensor senses the internal building pressure which is compared with the external building pressures”; PARKER only discloses a single internal pressure sensor. Additionally, his drawings only show a single internal pressure sensor. PARKER should have used words like “at least one internal sensor”, or “more than one internal sensor”; but he never does because back in 1999 that is all ASHRAE said was needed. Additionally, PARKER should have used words like “an internal sensor is compared with another internal sensor” or to determine “the differential pressure effects between internal areas” but he never does, because he never teaches anything about what he would do with this information. How much more obvious could PARKER have been; he never says a single word about determining a single internal pressure differential anywhere within his specification, or drawings.

With only one pressure sensor within the structure none of the prior art, including PARKER, could never determine even a single internal pressure differential. So if the prior art did ever add “controlled openings” to internal areas of a structure, there scheme would not have enough sensor data to determine when to open and/or when to close a single internal “opening”. This is clear proof that none of the prior art building pressure schemes, including PARKER, ever intended to add their openings to internal areas within the structure and an issue this important cannot now be assumed or inferred. PARKER does show several “external” pressure sensors and constantly claims the desire to determine “the differential pressure effects between internal and ambient pressures”; which can be accomplished by the prior art with its single internal structure pressure sensor. But again none of the prior art, including PARKER, ever claims or discloses a desire to “determine the differential pressure effects between any internal areas within the structure”; and they never could with their single internal pressure sensor.

Any and every, structure protection scheme and/or structure pressure control scheme that employs “static pressure sensors and/or static pressure theory” will fail and fail miserably, which includes PARKER. Applicant should know, he has worked on every known static system like this in existence and the fastest he could ever get a single one of them to react to a change in building pressure, was 6-10 minutes, or longer. The failures of these systems is what led him to obtain his first three granted patents that employ “dynamic pressure sensors and/or dynamic pressure theory” and his algorithms allowed his structure pressure control systems to react to structure pressure changes every four tenths of a second. His ideas on this subject produced structure pressure control systems that are at least 900-1,500 times faster than anything else available on this Planet. Interestingly, this applicant had to prove all of this nearly ten years ago, to obtain those three granted U.S. Patents that are all based on “control theory”, over PARKER and now he stuck addressing PARKER, again. He could use the ideas he already has active patents on, right now, to beat every existing prior art “high wind structure protection” scheme ever conceived, including PARKER. But his would also fail when the electricity failed.

Applicant's “dynamic building pressure control systems” which are totally based on “dynamic pressure sensors and theory” actually take five building pressure reading per second, then averages every group of two of these and uses this average to activate his control network. His “dynamic building pressure control systems” could be even faster if he chose not to improve his accuracy, through averaging. Applicant can prove all of this. He has 20+ positive pressure “dynamic building pressure control systems” in operation in a Ciba Specialty Chemical Plant in McIntosh, Ala., where many people have observed that when a door into a protected space is opened, thereby immediately lowering building pressure, the dampers controlled by applicant's scheme begin to move, immediately. Applicant's systems can literally respond to any and all building pressure challenges faster than you can read this very sentence describing their speed. Ciba had never been able to get a single static positive pressure building control system to operate and they had 30+ units at this Plant alone. Ciba can confirm this total failure of every static positive pressure building pressure control system they ever had. Please contact Ciba directly to verify this and ask them if they could ever get a single building pressure control system based on “static pressure sensors and theory” to react to a single opened door, much less accurately control building pressure. Their comment to the applicant was that they could not get a single building pressure control system to react to a single opened door, much less accurately control building pressure, and “their control dampers never seemed to move”. They have been amazed at how simple and elegant the applicant's “dynamic building pressure control systems” are and how easy they are to install and calibrate.

Every dynamic building pressure control system at Ciba has a digital control network operated by special algorithms written by this applicant; to produce a “positive” building pressure. This “positive pressure” is required by NFPA 496 Fire Codes. So after experiencing the total failure of every static positive pressure building pressure control system they ever had, Ciba said they would not purchase another single building positive pressure control system, even it was the new generation dynamic systems offered by this applicant; until they were given a money back guarantee that they would work and work fast, plus a method must be provided to continuously verify performance. Applicant's solution was a 0-10 volt analog output that came directly from his averaged digital sensor input data; which could then be connected to any computer available; providing the required incorruptible data log. This Ciba requirement also proved to be incredibly valuable to the applicant in ways he never imagined. Ciba went a step further and checked each building's pressure with a hand held manometer at a specific time; which was then time checked against the computer data logs, for accuracy. They can confirm that applicant's systems succeeded perfectly and they have the data logs to prove it.

The practical application of these patented ideas allowed the applicant to see things about structure pressures and their movements within a structure, which no one before him on the face of the Earth, had ever had the opportunity to see. Applicant hereby asserts that all before him mistakenly used static pressure sensors and theory in their attempts to control building pressure, and this error in judgment never actually allowed any of them to ever actually gain control of the pressure of a single structure since the beginning of time; so how could anyone before the applicant ever have the opportunity to see what he saw occur within a structure once he had gained control of it. As proof of this bold statement, applicant offers what happened at Ciba when Tropical Storm HANNA passed within miles of this Chemical Plant during the night of Sep. 14, 2002, with 60 mph winds and 80 mph gust. Please contact them directly to verify what applicant is about to say.

Ciba contacted the applicant on the 15^{th} and told him that his dynamic building pressure control systems had “gone haywire” and lost all control the previous day and that he needed to come find the reason for this “failure” and provide a solution. Applicant had found these data logs to be invaluable in finding solutions to previous problems that usually necessitated adjustments to his digital control algorithms. This had happened six times previously; each rewrite requiring the installation of new computer chips in each of the digital control networks involved; which applicant provided for free. Applicant knew that all educations are expensive and he was thankful to have a patience working partner such as Ciba, so he could have the chance to see and learn what no one before him had ever had the chance to see or know. Previous “failures” had allowed him to learn things he never knew, or even imagined could occur, within a structure. When one is the first to actually and accurately control the pressure of an entire structure, one is in for a long and arduous education on the intricacies of how air will move around within a structure, due to what applicant has named “pressure bubbles” and “pressure waves”; which that are almost impossible to predict but are controllable with fast and accurate sensor input data and a sophisticated digital control network with adapting algorithms.

Each structure has its own unique air flow patterns that arise from the air distribution design linked with internal room layout. With 20+ individual structures, he was given an incredible opportunity to learn from these different air distribution systems. These intricacies must be dealt with one-by-one and have taught this applicant how really tough it is to manage the pressures within an entire structure, especially when he also had to also contend with ASHRAE's incorrect air handler design information. In fact this applicant actually had to design his own special purpose air handlers to accomplish fast and accurate building pressure control and he has never seen anyone else design air handlers like this. Introducing large amounts of outside air into structures in the humid Southeast is extremely difficult and improper humidity control would spell disaster. This is why this applicant became involved in ASHRAE's Dehumidification Committee, for over two years. After almost two years of constant mathematical corrections he was finally able to get his control algorithms to efficiently and quickly handle each and every anomaly he had encounter within a structure; and truly doubts anyone else in the World has ever seen a single one of them. Ciba had become well versed in these chip change outs and always enjoyed the improved performance they provided. So, applicant just thought that the events of Sep. 14, 2002 were just another new unique situation he would have to solve with an algorithm re-write. He went there and worked with their lead Mechanical Engineer, Don (full name available for verification).

Applicant reviewed the computer data logs for the ten+ buildings involved in the “failure” and was unable at first to understand what he was seeing; so he spent the next six weeks studying them in detail, before he cracked the code on what had occurred during HANNA's high winds. Through tedious, mathematical comparison to normal operations; the applicant discovered something amazing and it is related on page 4, line 30 through page 5, line 6, of this specification. This in turn led to his discovery as described on page 10, line 1 through page 13, line 6, of this specification. After many more months of applied mathematics he knew that his digital systems were operating in a wave form frequency that resembled “noise” on the computer data logs, producing a “failure” alarm and loss of structure pressure control. All of his mathematics led him to the conclusion that the only possible cause was that the high velocity and turbulent winds of HANNA had blown much more air into these structures than normal, through the wind impact wall. This in turn set up pressure turbulence waves within the structure as his control network strived to regain control of structure pressure; which proved impossible until the turbulent winds finally moderated.

It is important to note for the record that these 20+ buildings at Ciba were fairly new, concrete block, industrial buildings with no opening windows and steel doors with heavy duty door closers. Plus, each building had undergone a meticulous inspection and all visible holes and/or leaks were sealed with caulk and then their entire exteriors were coated with two coats of a two-part epoxy paint. Applicant truly doubts that any standard structure is sealed half as good as these industrial buildings were sealed, and each one of them took approximately 8-15% of the building's volume in outside air, mer minute, to keep them at only a 0.10″ positive pressure; and even with all of this they still leaked badly when impacted by 60-80 mph turbulent winds. So please don't tell this applicant that standard structures do not leak like sieves, even during low wind conditions and especially during high velocity wind challenges. He has the installations, data logs and 30 years of experience, that prove otherwise.

ASHRAE and just about everyone else in this World operates under the illusion that buildings leak very little; leaving them with the lie of “stack effect”; as our structures become mold and mildew factories. PARKER is just one more lost soul. He should have used different language if he even thought that air was leaking into structures and leaving them at ever increasing high pressures during high wind events, as taught within this application. But neither PARKER, nor ASHRAE, nor anyone else can teach what they know nothing about. ASHRAE cannot admit that buildings leak, or then they would have to accurately determine exactly how much they leak and then dramatically increase their recommendations on the amounts of outside air amounts required to achieve their stated goal of simple neutral structure pressures and even more outside are would be required to achieve positive pressure structures. But currently ASHRAE and just about every Mechanical Engineer in the World is doing everything they can to reduce outside air requirements and “slickly” pointing to energy savings; while our structures actually become inefficient energy hogs and mold and mildew factories.

It became much easier for ASHRAE to kill the messenger than to deal with the truth. The truth has a funny habit of not caring who “believes” in it, regardless of how well educated the non believer is. This includes Global Climate Change and Worldwide Pollution. It is this applicant's opinion that just about every air handler sold over the past 100 years is not really suited for its intended purpose, leaving structures operating at negative pressures; turning the “skins/external walls” of our structures into low efficient “filters”, as large amounts of dirty, hot/cold, humid air are constantly “sucked” into structures. It cost 3-5 times more, to deal with this infiltration than to properly condition enough outside air to avoid a negative pressure structure. Pretending that a “stack effect” existed in our structures was much easier and cheaper than actually dealing with all of our “sick buildings” and the real truth. The real truth is that air is constantly “pulled” out of the upper floors of our structures by winds as described earlier in this patent, allowing air to be pulled up from the lower floors through elevator shafts and other “pathways of least resistance”; which accounts for air moving upwards within our structures. Every air handlers should be capable of handling much more outside air than currently designed, to preferably around 50% of total supply air flow of approximately one CFM per square foot; while still producing 48 degree F. dewpoint and 55 degree F. drybulb supply air, if we are ever going to conquer our humidity ravaged, energy hog, structures. ASHRAE's current misguided theory of using dedicated “outside air units” causes more structure pressure problems than they solve, by duplicating air flows and generating even more structure “pressure waves and/or bubbles”. If one refuses to see the real problem, they are left with only treating the symptoms of the real problem, even ASHRAE.

Please ask Ciba if they think structures “leak”. It would only take about 1-2% of building volume per minute to pressurize their structures to 0.10″ positive pressure, if they were hermetically sealed; but it takes a lot more, almost 8-15 times as much, or 800-1500% more. Applicant would love for someone, especially PARKER and/or ASHRAE, explain this difference; if “leaks” are not involved. Most Mechanical Engineers on projects applicant has worked on say he is wrong but he is am the only one that has ever made positive structure pressure control systems work and proved it with an analog output. These Mechanical Engineers doom their projects to failure due to their lack of real world experience; by providing far too little outside air for pressurization. Applicant has “walked away” from many projects because no one would listen to him. Without sufficient amounts of properly conditioned outside air, per minute, no structure pressure control system will work; no matter how sophisticated the control system is.

The real truth about how important it is to know the real truth about how much structures “leak” is the real reason why static pressure sensors and theory do not work, even under light wind conditions. So, ASHRAE and everyone else, including PARKER, who ever tried to use “static pressure sensors and theory” to measure structure pressure; proves that none of them even thought that structures “leaked” very much, if at all. These “static” systems would work if structures did not leak and structure pressures changed very little over any given hour. The slow speed of static pressure sensors and theory cannot account for these leaks until a whole lot of leaks have already occurred over a period of approximately 6-10 minutes, per applicant's thousands of hours spent trying to make them work. Only then can these static pressure sensors and theory even begin to detect an increase in the pressure of the fluid field within the structure; then they begin to react to a situation that has been going on for over six minutes; thereby setting into motion what applicant calls “a dog chasing its tail scenario” whereby these static pressure control systems attempt to correct a pressure problem that has already changed again; setting into motion a series of “pressure waves” and “pressure bubbles” within the structure that are impossible to stop until the static pressure control system is disabled; which is exactly how this applicant fount over 100 of them. If fact, he has never found a single structure pressure control system based on static pressure sensors and theory, operating properly, in his life.

No one before this applicant has ever understood how extremely important understanding structure leaking is, to understanding how to control structure pressure; or they surely would have never even tried to use static pressure sensors and theory. Only dynamic pressure sensor and theory that employ extremely accurate and fast thermal anemometry dynamic sensors to determine air velocity and direction, could ever accurately account for structure leaking. These dynamic sensors use temperature correction algorithms to determine air velocity and further employ two sensors in a line to accurately determine air flow direction. “Direction” is extremely important, how else could anyone ever determine whether air was moving into (negative), or out (positive) of a structure, through its leaks. Static pressure sensors and theory can never determine air flow “direction”; and antiquated thermistor technology is too slow. This applicant holds three active U.S. Patents that keep anyone else from using his patented dynamic structure pressure control systems, sensors and theory. So how could anyone ever teach what this applicant is teaching? They cannot teach what they know nothing about.

Applicant's digital, dynamic, positive structure pressure control systems at Ciba began to work perfectly again once the high winds had passed by the structures involved; just as they were programmed to do and ultimately no corrections were required. They had done everything they could to solve the situation they encountered. Applicant's special dynamic structure pressure control systems were required at this Ciba Plant by Federal requirements within NFPA 496, to prevent fugitive explosive gas releases at this to Plant, from entering electrical switch gear rooms, resulting in an explosion. These exact same dynamic systems could easily be used to protect all structures in America along with their occupants, especially any Governmental, Medical and/or Military structures; from chemical, biological and dirty bomb attacks that occur outside of the structure; while also dramatically enhancing structure humidity control, every day of the year. This “failure” at Ciba let directly to the discovery of the ideas taught in this patent involving high wind structure protection and wind energy structures. Applicant uncomfortably learned that even his super fast and super accurate patented dynamic building pressure control systems could not keep up with the turbulent wind gust generated by even this weak tropical storm, even though they leave all of the antiquated prior art systems, including PARKER, in the dust. So he knew a tornado and/or hurricane would drive his dynamic systems into almost immediate failure, even if the power were able to stay on.

So, this on the job training taught the applicant that structures definitely leak and that the resulting high wind generated pressure fluctuations within structures, occurred faster than even his existing patented dynamic four tenths of a second systems could adapt to. The self regulating, automatic, pressure operated, high wind building protection system as taught in this patent application at hand, represent a whole new level of system speed that will react to dynamic pressure fluctuations within a structure at around one tenth of a second; which is barely fast enough. This means that the applicant's new, novel and non obvious automatic, self regulating, high wind building protection systems taught in the patent application at hand are at least four times faster than his own dynamic systems; which makes them at least 3,600-6,000 times faster than anything else available on this Planet; which by reference includes all existing prior art and PARKER. An advancement of this magnitude deserves the granting of the broadest claims imaginable.

Applicant hereby declares that he is working on a “pressure relief valve” with a unique face/surface design that will increase even this speed. In “high wind structure protection” schemes, speed saves lives and structures, while lack thereof will end lives, allow severe injuries and destroy structures. As proof, applicant offers the over thirty times he has personally heard victims of tornadoes say on TV, “all this damage occurred in just five seconds”. All of the prior art “high wind structure protection” schemes are based on “static pressure sensors and/or theory”, so they will fail and fail miserably during every tornado they encounter. Applicant hereby asserts that none of them would ever even react to a single tornado, until it is miles past the structure involved, ruining more lives and structures. His “failure” at Ciba taught him that automatic, self regulating, pressure operated, openings as taught by the applicant in the patent application at hand, are the only ones that will ever respond fast enough during any and all high wind events. Any scheme that employs any form of “control theory” will waste far too much time gathering data, then “processing” it and then deciding what to do with it; while the high winds destroys the very structure around them; even ones that employ applicant's dynamic pressure control theory.

Therefore, all of the “controlled openings” of the prior art schemes are not fast enough, nor are they self regulating, nor are they automatic; leaving them totally externally influenced and/or totally controlled, because these openings are mounted “apart” from the pressure sensors, pressure transducers, controllers and/or data processors involved in their scheme, even when operated manually, which is just another form of external influence and/or external control. In fact the very word “controlled” is defined as “to exercise restraining or direction over; dominate; command” by Webster's, which clearly means that external influence and/or control is always involved; which also means they are anything but “independent”. These pressure sensors, pressure transducers, controllers and/or data processors have the sole purpose of influencing and/or controlling the controlled openings by telling them exactly when to open and when to close.

Since neither the drawings nor specifications of the prior art, including PARKER, shows or describes any of these pressure sensors, pressure transducers, controllers and/or data processors mounted directly onto any of the individual controlled openings themselves, these controlled openings are totally incapable of regulating themselves, or any form of independent operation. This can easily be proven by just simply disconnecting these controlled openings from the data processor and/or controller and these controlled openings will never move again, unless someone manually moves them, to which again is just another form of external influence and control. Or just simply disconnect all electrical power from PARKER's scheme, and nothing will ever happen again. It will just sit there as the next tornado or hurricane destroys his system, right along with the structure. In fact theses openings only operate after the data processor and/or controller waste valuable time processing the data from the pressure sensors and/or pressure transducers and then deciding which controlled openings to influence by controlling their opening and closing.

The openings of the applicant's scheme employ, no electricity, pressure sensors, pressure transducers, data processors and/or controllers of any kind; each of his individual openings only employs blatters, springs and/or weights so it can regulate itself. The captured pressure within the structure provides the necessary energy to operate these blatters, springs and/or weights on the applicant's pressure relief valves. No pressure sensors, pressure transducers, controlled openings, electric, solenoid, manual or pneumatic operators and/or any controls of any kind are required to operate the pressure relief valves and/or pressure transfer openings in applicant's structure protection scheme. All of which would fail when the power fails. Therefore, no controlled openings, no solenoid operated openings, no pneumatic openings, no motorized openings and/or no manual relief openings of any kind shall be applied to protect a structure from high winds. All of the energy required to operate all of the pressure relief valves in applicant's structure protection scheme, will totally be harnessed from the captured, channeled and/or concentrated wind energy that builds up within a structure during high winds.

Thus, there is a need in the current art of building construction for providing a method and apparatus that utilizes wind energy within a structure to allow structures to better survive hurricanes, tornadoes and/or other high wind challenges. It therefore is an objective of this invention to provide an automatic, self regulating method and apparatus for constructing structures that consist of a single pressure vessel, which can easily relieve/channel any and all excess dynamic wind pressure energy through its external surface and thereby to outside. Such a method and apparatus must be easy to apply, require no electricity and adequately produce a structure that is actually a single pressure vessel operating at a uniform pressure, which is not excessive. This method and apparatus may, or may not, also include self regulating, automatic, pressure operated, pressure relief dampers, vents, openings and/or valves and/or self regulating, automatic, pressure operated, pressure transfer openings on various internal surfaces to relieve any excess pressure that can build up within the structure as high pressure wind leaks in around windows, doors and/or minor wall imperfections, inflating the structure, and/or it's sealed cavities to destructive pressures. It is just these large pressure differentials generated by the inflated high pressures that build up within these enclosed sealed internal areas within the structure, due to wind intrusion that create the potential for the explosion of these enclosed sealed, separate, internal, pressure vessels within the structure, and consequently leading to a catastrophic failure of the entire structure.

In the patent application at hand, “external” refers to “any and/or all surfaces, areas and spaces that connect with an outside”; while “internal”, “includes any and/or all surfaces, areas and/or spaces located within the single pressure vessel within a structure”; and “internal surface” refers to “any surface that is located within these internal areas”. For clarity “external surface” is used to define “the surface that connects with an outside”; to differentiate it from “internal surface”. Therefore for this invention, “the external surface of the structure” refers to “all surfaces that are situated at the external boundary of the structure itself”. “The external surface of the internal areas and/or external surface of the single pressure vessel” refers to “the surface that is the external boundary of the internal areas of the single pressure vessel”. There are times where the external surface of the internal areas of the single pressure vessel, may not always be the external surface of the structure due to construction methods that place unprotected areas that are not part of the single pressure vessel, between the internal areas and the external surface of the structure. This situation is described with language such as “the external surface of the internal areas” and/or “the external surface of the single pressure vessel”; which refers to the same surface and are interchangeable. To further clarify, “outside” refers to all areas of any kind that are beyond any and all of the external surfaces just defined”. So it is possible for a single structure to have two “outsides”; one “outside” of the single pressure vessel; and another one that is “outside” of the structure itself.

The prior art, including PARKER, never shows a single opening, on a single internal surface' within the structure. PARKER is the primary prior art and he only show openings on the “various surfaces” and/or “various external surfaces” of the structure; and per Webster's definition for “surface” as “the external boundary an object”, only “external surfaces” apply. Yes, PARKER's openings will go through these external surfaces and reach “internal surfaces”, but not in any way that is similar to what this applicant is teaching or claiming. If PARKER wanted to teach mounting his openings on internal surfaces and why; then he should have clearly said so, fully explained why and used different language such as “various internal surfaces” and defined them as this applicant does. PARKER very obviously chose not to because he saw no need for them. Neither his specification nor his drawings ever mentions any requirement or desire to add openings to any internal area and/or surface, within the structure, and such an important issue cannot just now be assumed, or inferred. Additional support for this argument is shown on page 21, line 23 through page 22, line 31. Applicant respectfully request the exact patent and phrases therein that refute these statements. He looked and never found a single one. The patent application at hand is the only high wind structure protection scheme that has pressure relief valves and/or pressure transfer openings; on various internal surfaces, within the structure.

For a description of “transfer opening”, applicant referred to dictionary.com where he only found a definition for “transfer” as “to convey or cause to pass from one place to another”. For the patent application at hand “pressure transfer opening”, refers “to any self regulating, automatic, pressure operated, opening that allows air and/or pressure to be conveyed/transferred from one space to another without any restrictions, every minute of the day and may be as basic as a simple hole in a surface, which may or may not have a cover, that allows pressure to automatically equalize between different spaces”. This makes them both “self regulating” and “automatic”, since no external influence or control of any kind is required for them to operate properly. Plus they are “pressure operated” because pressure differences between various spaces will provide the necessary energy to move air and/or pressure through these openings. These self regulating, automatic, pressure operated transfer openings can be any now known device or any device developed in the future that fits the above description. There is no reason to limit the design of these self regulating, automatic, pressure operated, pressure transfer openings at this time, since no one currently employs the principals as described in this patent. Additionally, the term “weather resistant pressure transfer opening” applies to all pressure transfer openings that open to outside and must be constructed of weather resistant material and in weather resistant dimensions to withstand high winds, salt water and extremely bad weather, for example. To avoid confusion, the standard term “pressure transfer opening” applies to all pressure transfer openings whether they are fully removed from the outside and mounted on internal surfaces within the single pressure vessel, or if they are located where they can encounter high winds and bad weather.

Applicant has done extensive research on the exact size, type and location of these pressure transfer openings and the practical application of the principals taught by this patent will most certainly reveal even more information. Applicant added over 40 leaky, recessed, incandescent, lights to the ceiling and roof cavities of his town home on Pensacola Beach, to act as self regulating, automatic, pressure operated, pressure transfer openings during IVAN, and they worked perfectly. They also provided great lighting flexibility. Many other common products can also be used as pressure transfer openings, while serving other practical and useful purposes. These pressure transfer openings will be approximately located as shown on the drawings and mounted per the manufacturer's recommendations so that all warranties will remain in effect.

The desired result for the “pressure transfer opening” and/or a “pressure relief valve” is the same: to allow air to move between various, desired spaces and allow the pressure to easily, automatically and quickly equalize between these desired spaces and produce a uniform, equalized pressure throughout the structure and/or single pressure vessel. The primary difference between a “pressure relief valve” and a “pressure transfer opening” is that a “pressure transfer opening” is allowing air and/or pressure to, automatically move from one space to another without any restrictions, every minute, of every day, while a “pressure relief valve” will allow air and/or pressure to, automatically move from one space to another, only after, the required/desired relief pressure, has been reached within one of the spaces involved and then closes again once the pressure situation is solved; such as the pressure of the area involved is reduced below a specified maximum set point by operation of the pressure relief valve. It should be noted that no one currently puts holes in the various internal surfaces of structures as taught by the patent application at hand. Instead everyone operates under the misconception that all internal surfaces within structures must be sealed as well as possible and any holes are totally unacceptable, especially in humid climates. They could not be more incorrect.

It is impossible to decide at this stage exactly which opening should be applied at the locations shown on the drawings. There are many variables that determine exactly which type of opening should be used on any given structure. To decide before all of the variables are known would lead to operational and/or humidity problems and application confusion. This is why there is such detail in describing the use of “vapor retarders”, within this specification. Whether or not a vapor retarder is applied, along with its exact location, and exact permeability, can dramatically effect which opening should be used in a particular installation. The outside climate can also dramatically effect which opening should be used in a particular installation. Also, structures that have attics and/or other areas that cannot be sealed to outside offer even more variables as to which opening should be used in a particular location, or application. Applicant owned a business that focused on specialized dehumidification equipment sales and installation. He has designed and installed many special dehumidification systems within the most humid areas of America and all are still operating properly. He has gained knowledge that few can match in America, or the World, concerning exactly how humidity and pressure can move within a structure.

Applicant hereby declares, that he learned most of what he knows about structure pressure by studying the intricacies and mathematics of exactly how humidity moves within a structure; involving Boyles Law and Fick's Law, the primary Laws of Diffusion. As pressure differences within a structure move to reach equilibrium, they will easily move humidity around within that structure. It is extremely easier to measure the movement of absolute humidity within a structure, even at low dewpoints, than it is to measure the movement of pressure within the same structure. Especially low pressure differentials, where humidity measurement may be the only way. He discovered the hard way that pressure differences within structures can dramatically affect the performance of even the best designed humidity control system. He learned early in the game that he had to learn how to control structure pressures, before he could master the control of structure humidity. This on the job humidity and structure pressure education, led to his first three granted U.S. Patents.

The general function of each is the same as stated previously and those “skilled in the art” of humidity control will easily be able to determine exactly when and where, which opening should be chosen based on information contained within his patent specification. For example, say two exactly same structures are constructed, one is located where for most of the year the climate is considered cold like Duluth, Minn., while the other is located where for most of the year the climate is considered hot and humid like in Panama City, Fla. In the winter time in Duluth the only “drying force” is the low outside dewpoint of around 20 degrees F. If self regulating, transfer openings are used on the internal surfaces of an external wall cavity in Duluth, the Laws of Diffusion would allow moisture generated by the occupants through showers, cooking, breathing and the like to be pulled into this cavity where the cold dry bulb temperature from outside could freeze this moisture, expand it and literally tear the wall apart. So, in Duluth only a pressure relief valve would prevent structural damage and must be the only one of the two used in these locations.

While during the summer time in Panama City, the 55 degree F. dewpoint generated by the interior air conditioner, provides the only “drying force” when outside dewpoints soar to 80 degrees F. or above. Here only pressure transfer openings mounted on the internal surface of this same external wall cavity, would allow it to be continuously dried out, as once again the Laws of Diffusion allow humidity to continuously enter the structure from outside at around 7,500 fpm based on the differential vapor pressures linked with mathematics by Bernoulli; which he derived directly from Pascal's, Boyles and Fick's Laws. Luckily the holes are extremely small. So in Panama City, only a pressure transfer opening mounted on the internal surface of this external cavity, would allow it to continuously remain dry. If a pressure relief valve was used here, this external wall cavity would only dry out during high wind events when the pressure operated, pressure relief opening is forced open by pressure differentials. This would allow significant mold and/or mildew to grow within this external wall cavity in Panama City when no hurricane or tornado is experienced.

Right now over two million structures, in the humid American Southeast could have uncontrolled mold and mildew growing within their external structure cavities. How would any other patent in the World address this important issue? Applicant's scheme is the first ever to protect a structure from high winds, efficiently produce electrical power, and dramatically improve structure internal humid control. Applicant may be the only person in the World that has spent over thirty years studying dynamic pressure, structure pressure control and structure humidity control. Allowing him to fully understand and interrelate all of the principals, mathematics and Laws of Physics involved, into one concise method and apparatus. Therefore, no one before him could have ever invented the new, novel and non-obvious scheme taught in the patent application at hand, or he would have heard about them, or met them on a project, or met them through ASHRAE.

Applicant can think of over twenty similar, location specific requirements where similar problems could occur if a pressure transfer opening were used in lieu of a pressure relief valve, or visa-versa. Another interesting fact is that the 50% or less relative humidity level generated in these external wall cavities by employing pressure transfer openings in hot and humid climates as described above and further within this patent application will create what is called a “high stress environment” for roaches and other insects; which should keep them from entering a home/structure protected by applicant's scheme. Again employing a pressure relief valve in exactly the same location would allow roaches and other insects to enter the structure. The current structure design of sealing all external structure cavities, also prevents these cavities from drying out, leaving insects to freely move into and out of the structure Back in 2006, shortly after filing the parent application for this continuation in part, applicant got on the internet and studied roaches and found that they breathe through their skin and areas of 50% or less relative humidity will dry them out and they will die unless they escape. So, another positive byproduct of this patent application at hand would be less roach infestations in structures that employ what applicant is teaching.

Also, to completely and exactly clarify such an interrelated set of variables as to which opening should be used, and under which exact humidity and temperature and pressure conditions, would result in a patent application that would easily be over 200 pages long and be difficult for any lay person to comprehend and be expensive and time consuming for the applicant to file. The resulting confusion could easily mislead someone into using exactly the wrong opening, at exactly the wrong time, in exactly the wrong location and in exactly the wrong outside climate. While accurately choosing exactly when to use which opening will actually produce structures that not only can withstand high winds, but also produce enhanced structure humidity control and/or less insect infestations, at no additional cost, but at considerable energy savings. No other prior art patent in existence, offers this possibility. Applicant employed all he has learned over the past forty years into the patent application at hand.

Applicant's 32 years of living on Pensacola Beach, Fla. and the 20 plus hurricanes he had to deal with, taught him that the power always goes out during a hurricane and any control theory structure protection system dependent on electricity in any way, will go out too. So, pressure relief valves and/or pressure transfer openings that harness the captured wind pressure that builds up within the structure as their only required energy source, as taught in the patent application at hand, are the only ones that will continue to work when they are needed, no matter what, no matter when. Applicant built the invention that this patent teaches, onto his own home, and it taught him that it will work, no matter what. His electricity went out eight hours before he experienced the 138 mph strongest winds of hurricane IVAN, on Sep. 15, 2004, as it passed very close to his home, in the pitch black darkness of night, and his scheme worded perfectly without any electrical power, and/or any conscious control, manual control, controlled to openings, controllers, data processors, sensors, or any form of external control theory, or any external influence and/or assistance of any kind. He was able to calmly sit back, take notes, let the storm teach him things few have ever seen, while watching it work perfectly and quickly through all wind increases and directional changes.

By applying these principals to his own town home located at 1521 Via Deluna, on Pensacola Beach, Fla., applicant hereby declares that it is the first working prototype of a method and apparatus to utilize wind energy within a structure as taught in this patent. This prototype provided the applicant with valuable knowledge and insight, as these principals allowed his town home to withstand the devastating winds of hurricane IVAN, on Sep. 15, 2004. He stayed in his home throughout the hurricane and associated 130+ mph winds and eight foot storm surge, to see for himself when, how and where his ideas on this subject, might fail. His ideas did not fail and are now described in this invention. He stayed in his town home for nine additional days after IVAN, without electricity or running water, while the area was under Martial Law, so he could continue to study the useful, new, novel and non-obvious ideas taught by this application.

Applicant sat in his home during an actual category 3 hurricane, to test his invention. Applicant literally risked his life to learn what he is teaching. Applicant figured that before he ever asked another human being to risk their lives in structures modified with his ideas, he must verify all of his mathematics and then risk his own life, first. He knew it was the only way to see and experience what actually happened. He sat next to the wind impact wall of his home and experienced the internal sheetrock wall expand inwards, and felt air blow out of the holes he had cut in this wall. He instantly knew they had to be larger, so he corrected his formulas. He also saw and felt his double pane windows flex inward by over an inch, immediately as he heard the wind gust outside, and they had high quality storm shutters over them, outside. One of his next door neighbors also had high quality storm shutters but several of their windows and their roof still failed. Experiencing an actual category 3 hurricane provides critical information on exactly what happens during a high wind event.

Applicant hereby declares that at the height of the storm he saw and felt the wind impact side of his home switch back and forth from one side to the exact opposite side of his home in an instant. This means that the 138 mph impact winds switched 180 degrees in an instant. Applicant doubts that any control theory building protection scheme; which depends on static pressure sensors, pressure transducers, data processors and/or controllers could ever sense this rapid powerful change and then perform the math fast enough to determine which controlled opening to open and which one to close. All prior art schemes will fail, because their openings will never work fast enough, to solve what the applicant experienced. Applicant's roof mounted self regulating, automatic, pressure actuated, pressure relief skylight continued to work perfectly during this 180 degree event, popping open as fast as every few seconds without any interruptions or delays, just as his mathematics and theories said it would. Many times this skylight would open multiple times in a single second, sounding like machine gun fire, startling the applicant.

Applicant hereby declares that while observing the operation of his self regulating, automatic, pressure operated, pressure relief skylight, during IVAN as described above, applicant learned exactly how powerful the mechanical energy of this capture wind energy is and that he had never accurately calculated or observed this force within a structure before. He had seen the computer data logs from Ciba, but never thought it was so powerful. Within a day he realized how this energy could be captured, channeled, concentrated and/or harnessed to power any type, size, form or shape of wind powered device, even in winds down to 1.0 mph and as high as 240 mph, regardless of wind direction, including but not limited to wind powered electrical power generators. Any applicable form, type, size or shape of wind powered device currently existing or invented in the future can be used within his wind energy structures.

Thus, there is a need in the current art of wind power for a method and apparatus to utilize the dynamic pressure energy of wind within a structure, to operate any form, type and size of wind powered device including any form, type and size of wind powered electrical power generator and/or any connected machine device. These are some of the objectives of this invention. Such method and apparatus must be easy to apply and adequately produce sufficient energy.

### SUMMARY OF THE INVENTION

A new or existing structure constructed as a single pressure vessel includes a structure with an external surface and at least one internal surface within an internal area that has at least one external surface separating said internal area from an outside. More than one room with at least one surface can be involved with at least one floor, along with attic and/or roof cavity areas that are sealed to outside. In this situation, the “outside” of the structure itself is also the “outside” of the single pressure vessel. Multiple floor structures are included by reference and inference. The attic and/or roof cavity areas as named include any and all spaces attached to the structure and located directly below the roof structure and directly above the living and/or working area. Basements, party rooms, family rooms, stairways, enclosed pools, mechanical rooms, utility rooms and/or all other attached, enclosed, structures that the designer, architect, etc. . . . chooses to protect and include within the single pressure vessel are also included by reference.

One objective of this patent is to design structures where internal areas, such as but not limited to, attics, rooms, floors and/or ceiling cavities, floor cavities, wall cavities and/or any and all interstitial areas, etc. . . . , within the structure, along with the internal areas of any desired attached, enclosed, structures are constructed into a “single pressure vessel” as defined earlier within this application; where all of these internal areas can communicate with each other and operate at a uniform pressure. By interstitial area, we refer to any space and/or area between other any and all other spaces and/or areas. The internal areas to be protected will be sealed to all surrounding areas, except each other, within the structure. Practical application of this embodiment will involve the deletion of all soffit vents, roof vents, and roof turbine vents, ridge vents, gable vents, etc. . . . Attics are now completely sealed to outside except for the addition of weather resistant pressure relief valves at the external surface of the internal areas.

According to a further embodiment pressure transfer openings are added to the various internal surfaces of the attic ceiling surface and/or roof cavity surface, of the top floor of the structure, creating a channel to allow this captured pressure to easily, automatically and quickly equalize between the attic and/or roof cavity and the enclosed internal living areas and/or working areas thereby generating a single pressure vessel, that will operate at a uniform pressure. This attic ceiling surface, refers to any and all surfaces that exist between the attic as described, and the enclosed, internal living and/or working areas. In other cases, ceiling refers also to the upper surface of any living or working area. A ceiling cavity is the area between a ceiling surface and the attic, roof, or floor surface above it. Sometimes a floor cavity from one floor and ceiling cavity from the floor below, can be the same cavity, and can be called either, or both.

This embodiment can involve the installation of insulation just below the roof surface, or even on top of it. For the past 100+ years, the surface between the attic area and enclosed living and/or working areas has been insulated, and the attic was allowed to gain heat. Sealing the external surface of the attic to outside will allow heat to increase in the attic area, unless the insulation is moved to the roof. Moving the insulation is not critical to the design of a single pressure vessel, but instead is just a recommendation that will allow for energy savings. Applicant feels that if insulation is installed at the structure's roof, then insulation is not required at the attic ceiling surface located between the attic areas, and the enclosed living and/or working areas.

According to another aspect of the invention, the internal areas of any and/or all desired attached and enclosed structures can also be added to the protected area and then sealed to all surrounding areas, except each other and the structure core itself; thereby increasing the size of the single pressure vessel. Practical application of this aspect will also involve the addition of pressure transfer openings and/or pressure relief valves to the internal surfaces of all internal areas and/or spaces within the attached structures, creating a channel allowing this captured pressure to easily, automatically and quickly equalize between all of the internal areas of all of the attached structures involved, thereby generating a single pressure vessel that will operate at a uniform pressure, and preventing the creation of pressure differences between any of these internal areas and/or spaces.

According to another embodiment, the external ceiling cavities, floor cavities, wall cavities and/or any and all interstitial areas, etc. . . . , within the structure will also have pressure transfer openings and/or pressure relief valves added to their internal surfaces, creating channels that allows this captured pressure to easily, automatically and quickly equalize between these cavities and the internal areas of the single pressure vessel. This will prevent the uncontrolled buildup of pressure within these external ceiling cavities, floor cavities, wall cavities and/or any and all interstitial areas, etc. . . . , within the structure. For the past 40+ years these external cavities have always been sealed to all internal areas and a vapor retarder was normally located on the internal side of these external cavities. Allowing pressure to equalize within these external ceiling cavities, floor cavities, wall cavities and/or any and all interstitial areas, etc. . . . , and the internal areas of the single pressure vessel within the structure, will mean that the vapor retarder should be moved to the external most side of these external cavities in colder climates, or to the outside of the external surfaces of these external cavities, but inside of the weather resistant external coating in humid climates, so that these entire external cavities now become part of the single pressure vessel.

A vapor retarder should be included to assist in sealing the enclosed internal areas within the structure and creating the desired single pressure vessel, but is not required to create a single pressure vessel. A vapor retarder will provide increased humidity control and increased energy savings. In hot, humid locations, applicant feels that the best location for this vapor retarder is just behind the weather resistant external coating of the structure (brick, vinyl siding, wood siding, aluminum siding, stucco, etc. . . . ). When the vapor retarder is located here, a space for ventilation drying should be allowed between the vapor retarder and the weather resistant external coasting, with vent holes at the top and bottom of each floor that open to outside, so that moisture is allowed to escape. A vapor retarder should not be applied inside the wall structure, as this would allow moisture to become trapped between it and the weather resistant external coating, resulting in significant mold, mildew and/or rot. A vapor retarder should also be applied to the external most surface of the roof structure, for the same reasons. In both of these cases, external most means the surface of the roof structure that is the closest to an outside, so as to maximize the size of the single pressure vessel. Applicant also feels that the best vapor retarder for roof membranes are tar based, peel and stick products that offer great vapor protection and help to keep the roof membrane in place during high, strong winds. This peel and stick type of vapor retarder should be applied to the external surface of the roof structure, and just below the roof membrane itself. Again, a vapor retarder should not be applied below the roof structure, as this would allow moisture to become trapped between it and the roof membrane, resulting in significant mold, mildew and/or rot.

According to another embodiment, internal areas, such as but not limited to, attics, rooms, floors and/or ceiling cavities, floor cavities, wall cavities and/or any and all interstitial areas, etc. . . . , within the structure, can also have pressure transfer openings and/or pressure relief valves added to their internal surfaces, creating channels which allow this captured pressure to, automatically and easily equalize within the single pressure vessel. This will also prevent the uncontrolled buildup of pressure within these internal areas, such as but not limited to, attics, rooms, floors and/or internal ceiling cavities, floor cavities, wall cavities and/or any and all interstitial areas, etc. . . . , within the structure, before they become explosive. If insulation is added to these internal cavities, then vapor retarders should not be employed unless some specific reason requires them. If a vapor retarder is employed to internal cavities, care should be taken to prevent the generation of any separate pressure vessels, within the structure, that could also trap moisture and/or pressure.

According to another embodiment of the invention pressure relief valves may be added to automatically relieve built up internal pressures during any and all high wind challenges. Pressure relief valves have been applied to structures in the past but not as used, or described by applicant. They can be added to various internal surfaces within the structure, creating channels to accomplish the single pressure vessel principal. They can also be added to the external surface of the internal areas and/or single pressure vessel and thereby outside. Due to the high winds involved, walls are not suitable locations, as to deployed by previous patents. The aerodynamics of high winds could easily prevent a pressure relief valve located on a wall from operating at the proper relief pressure when needed. The same does not hold true for roof surfaces, due to the well known pressure envelope that develops over roof surfaces, combined with the aerodynamic lift that occurs over roofs, during high velocity wind events.

So, for proper operation and protection weather resistant pressure relief valves to outside, must always be located on roof surfaces and/or on the external surface of the internal areas and/or single pressure vessel, at or near the roof and/or top of the structure. Directly after IVAN, applicant observed that the roof membranes of over 35 homes on Pensacola Beach had undergone catastrophic and uncontrolled explosive pressure releases, resulting in the roof membrane being blown up into a bubble at its weakest spot. Harnessing the captured pressure to operate these weather resistant pressure relief valves to relieve the built up pressure right at the external surface of all internal areas, will prevent just this type of explosive pressure release. If sloped roofs are involved, then weather resistant pressure relief valves should be installed at the external surface of all internal areas, on or near all sloped roof surfaces, to prevent wind from blowing directly on all of them. So, every sloped roof surface should have at least one weather resistant pressure relief valve installed on or near it. Flat roofs can have as few as one weather resistant pressure relief valve, provided it is sized and located properly. There are times where this external surface of the internal areas of the single pressure vessel, may not always be the external surface of the structure due to construction methods that place unprotected areas that are not part of the single pressure vessel, between these internal areas and the external surface of the structure. This situation is described and defined with language such as “the external surface of the internal areas” and/or “the external surface of the single pressure vessel”; which refer to the same surface and are interchangeable.

The release pressure for these weather resistant pressure relief valves can be set at any relief pressure desired. Applicant used an existing operable sky light on his town home, and set it to relief at a pressure well below the failure point of all external surfaces. At the height of IVAN, this sky light was relieving the built up pressures within the structure, to outside, about every 2 seconds or less, with some releases sounding like machine gun fire every fraction of a second, and would then reset with a loud pop, and some releases could even be felt in his ears; reflecting substantial pressure differentials. Applicant used the failure pressure of his roof membrane, as his design relief pressure. He found it to be his weakest external surface. No external surface failed on his town home during IVAN, while both of his next door neighbors lost several windows and doors, plus both lost their roof membranes to the explosive pressure release described above, to the same wind and pressure challenges as the applicant's home. For other structures, other surfaces may have a lower failure pressure.

By reviewing all of the failure pressures, of all of the external surfaces (windows, doors, skylights, walls, roof membrane, etc. . . . ) for a particular structure, and then using a percentage of the lowest known failure pressure, an adequate relief pressure can easily be determined. Maximum rated wind loads for various external surfaces can easily be converted to failure pressures, by applying simple velocity pressure (dynamic pressure) conversion formulas. These weather resistant pressure relief valves can be any now known device or any device developed in the future that will harness the captured pressure within the structure, to self regulate and create a channel that allows pressure to be automatically relieved to outside, so as to prevent catastrophic failure of a standard structure and/or roof membrane. There is no reason to limit the design of this weather resistant pressure relief valve at this time, since no one currently employs the principals as described in this patent. Plus, the practical application of these principals may reveal even more priority information on how to automatically relieve pressure build ups, before they become catastrophic. According to another aspect of the invention, the captured pressure within the structure can be harnessed to automatically operate these pressure relief valves at any and all internal surfaces within the structure, including but not limited to various attics, rooms, floors and/or external and/or internal ceiling cavities, floor cavities, wall cavities and/or any and all interstitial areas, etc. . . . , within the single pressure vessel, to provide protection from uncontrolled pressure differentials, during a catastrophic event.

According to another embodiment, new or existing structures that have attics and/or roof cavities that cannot be sealed to outside, can be modified with pressure relief valves between the sealed living and/or working internal areas, and these unsealed attic areas and/or unsealed roof cavities at the external surface of all internal areas, to relieve pressures during a catastrophic event. In this situation a single structure may have two “outsides”; one “outside” of the single pressure vessel and another one that is “outside” of the structure itself. Pressure transfer openings should not be used at these locations, as they will allow humidity to uncontrollably enter into the working and/or living area. Applicant hereby declares that he has never seen anyone else use pressure relief valves at these internal surfaces, much less pressure transfer openings. According to another aspect of the invention pressure relief valves and/or pressure transfer openings may be added between any or all attached, enclosed, structures of the new or existing structure that have attics and/or roof cavities that cannot be sealed to outside, including but not limited to the various internal surfaces of rooms, floors and/or external and/or internal ceiling cavities, floor cavities, wall cavities and/or any and all interstitial areas, etc. . . . , within all of the structures involved, to achieve a single pressure vessel. To prevent uncontrolled pressure differentials during a catastrophic event, weather resistant pressure relief valves should be used at the external surface of all of the internal areas of the single pressure vessel to prevent the uncontrolled entrance of humidity, where pressure transfer openings could allow humidity to enter and move throughout the structure causing mold or mildew problems. Weather resistant pressure relief valves can also be added to the roof surface of these unsealed attic and/or roof cavities, to readily, automatically and easily relieve pressure to outside. Since moisture intrusion is not a concern here weather resistant pressure transfer openings could also be used.

According to another embodiment, internal ceiling cavities, floor cavities, wall cavities and/or any and all interstitial areas, etc. . . . , within these structures with unsealed attics and/or roof cavities, can also have pressure transfer openings and/or pressure relief valves added to them, creating channels that allow this captured pressure to easily, automatically and quickly equalize within the single pressure vessel. This will also to prevent the uncontrolled buildup of pressure within these internal ceiling cavities, floor cavities, wall cavities and/or any and all interstitial areas, etc. . . . , before they become explosive. If insulation is added to these internal cavities, then vapor retarders should not be employed unless some specific reason requires them. If vapor retarders are employed in internal ceiling cavities, floor cavities, wall cavities and/or any and all interstitial areas, etc. and/or any internal walls, floors and ceilings, care should be taken to prevent the generation of any separate pressure vessels, within the structure, that could trap moisture and/or pressure.

According to another embodiment, the capturing, channeling, concentrating and/or harnessing of wind energy involves a structure with an internal area with at least one external surface separating this internal area from an outside; with channels in the external surface of the internal area. These channels would connect the internal area within this structure with the outside to provide another method and apparatus to utilize wind energy within a structure to operate any type, form, size or shape of wind powered device, even in winds down to 1.0 mph, for many uses including a new and more efficient way to generate electrical power. For the invention at hand, these “wind energy structures” are “any attempt, strategy, scheme, occurrence, method and/or apparatus to capture, channel, concentrate, harness and/or utilize wind, wind power, wind pressure, pressure from wind, dynamic pressure, dynamic wind pressure, dynamic wind pressure energy, wind energy and/or any version thereof in any way imaginable, within a structure regardless of its size, shape, form and/or type”. “Capture”, “channel”, “concentrate”, “harness” and “utilize” are clearly defined earlier in this specification; along with “damper”, “vent”, “opening” and “valve”.

For this invention, “stages” is defined as “any attempt, strategy, scheme, occurrence, method and/or apparatus for providing a series of positions and/or stations within a wind energy structure where multiple wind powered devices and/or machine devices can be employed”. Additionally for the invention at hand, “channel” is a primary word when used in describing and/or defining these wind energy structures; and is understood to be “any channel, tube, pathway, track, louver, damper, device, machine, structure, opening and/or anything, etc that is conformed to be useful in any attempt, strategy, scheme, occurrence, method and/or apparatus to accomplish the capturing, channeling, concentrating, harnessing and/or utilizing of wind energy within a structure”. As desired and/or required, some “channels” will constantly remain open and/or closed; while others will operate and move to open and/or move to close based on a “predetermined set point”. These operable “channels” within “wind energy structures” can operate “automatically” as defined earlier within this specification relying on wind energy and requiring no outside influence and/or assistance for their operation and/or they can be controlled manually and/or controlled by “control theory” as defined earlier; and/or any mix, version, attempt, strategy, scheme, method and/or apparatus involving automatic, manual and/or control theory, imaginable.

For the patent application at hand this “predetermined set point” could be based on any one and/or all of the relevant issues involved, such as but not limited to: “internal pressure”, “outside pressure”, “electrical demand”, “wind speed”, “wind direction”, “wind device rotor speed and/or pressure”, “forecasted weather” and/or “time of day, etc. Applicant has written over 200 control algorithms for various goals and each of these issues and more can be analyzed to determine when to open and/or when to close a specific “channel”. The actual “predetermined set point” for any specific “channel” may be different than for any other “channel”, based on how all of the variables involved are “weighted”. Some installations will have variables not experienced at other installations. All “channels” must be “weather resistant”, constructed of weather resistant material and in weather resistant dimensions for example; since rain, high winds and extremely bad weather must flow throughout applicant's wind energy structures, for them to operate properly during all hurricanes and tornadoes.

Any applicable form, type, size or shape of wind powered electrical generator currently existing or invented in the future can be used within this structure. For example and not so as to limit the invention, applicant envisions economical smaller wind energy structures that could be installed on every home in America, resulting in a dramatic increase in energy savings and independence, capable of withstanding and operating throughout hurricanes and/or tornadoes, allowing people to more safely and comfortably shelter in place. Just for example and not by way of limitation, these could be about the diameter of a 55 gallon drum and about 50 feet tall with individual rotating sections every five feet or so, with minimal internal obstructions and vertical inlet slots with or without scoops, to channel wind energy into the structure as they swivel.

These slots will automatically align with the direction of the incoming wind by employing simple wind vanes positioned on the drum, opposite each slot. As the wind direction changes over height, the individual sections could aim in different directions to channel even more wind energy into the structure where it is captured and then concentrated, to increase efficiency. In rural, poor, or third world areas, actual 55 gallon drums could be used to save cost. For clarity, these individual rotating sections of the 50 foot tall structure are not wind powered devices by themselves. Their purpose is to channel wind energy into the structure where it is captured. They stop rotating once their inlet slots are aligned with the incoming wind, so that once again, all of the wind energy will be captured, channeled, concentrated and/or harnessed, within the structure.

A single wind powered electrical generator could be mounted just below the top and/or in stages over height, and/or the entire height could be a series of horizontal fan blades, similar to jet engine blades, connected to single and/or multiple rotating shafts, all driving a single machine device and/or multiple machine devices over the height to utilize this wind energy. In this case the jet blades are the wind powered device and any form, type, shape and/or size of machine device including electrical generators could be directly connected and/or through belts, drive lines and/or the like with the wind powered device inside of the wind energy structure, in any attempt, strategy, scheme, occurrence, method and/or apparatus imaginable. Additionally, any form, type, size and/or shape of machine device could be mounted outside of the wind energy structure and connected with the wind powered device through belts, drive lines and/or the like. So while all the wind power is created within the structure, the force, motion and/or energy generated can be transmitted outside of the structure and utilized in any attempt, strategy, scheme, occurrence, method and/or apparatus imaginable.

These wind energy structures could have channels on all the external surfaces that experience wind impact, or multiple rotating channels that will manually, automatically and/or through control theory, follow changing wind directions over height. Through further automatic, manual and/or control theory operation, these channels on the wind impact external surface will move to open at a predetermined set point and allow wind pressure energy to enter the structure; while all of the other channels could move to close at a predetermined set point, capturing the wind energy where it can be diverted into many other channels. It is understood that any type of channel, even motorized ones, could be used in this structure, since no other existing patent employs them in a similar way. So even during light wind conditions, wind energy will become captured within the structure and then further channeled where it concentrates and increases over the height of the structure through automatic, manual and/or control theory operation. If the captured dynamic pressure becomes greater than the velocity pressure of the wind on the upper channels, then these channels could move to close at a predetermined set point and prevent the loss of any of this captured wind energy from within the structure. Additionally, wind energy could be diverted into any number, direction and/or type of channels and/or stages, by employing additional channels that open and/or close at predetermined set points, within the structure to maximize the energy of the available wind. Applicant's calculations show that only a few floors are needed to approach maximization. In a standard structure, rooms directly over other rooms for as few as five floors could be converted into wind energy structures with wind powered devices on the top/roof or in stages over height, connected with nearby electrical, industrial and/or commercial machine devices; while adjacent rooms would continue to serve normal functions. It is understood that the word floor is used also to describe any additional height added to the wind energy structure and not just a standard structure floor.

Air straightening vanes can be added to these channels as desired to assure a smooth entrance flow into the wind powered device, so as to maximize power generation. They would also assist in preventing debris from being drawn into a wind powered device during hurricanes and tornadoes. Applicant's research reveals that wind powered devices mounted at the roof line and/or top of a dynamic wind pressure energy structure, should have extended walls often called parapets which describe the same surface, that extend a little higher than a top of the wind powered device to prevent high winds from directly impacting the blades; which will actually reduce the efficiency of a center flow wind powered device. Wind powered devices mounted anywhere within the structure could have channels leading to the top of the structure that could open at a predetermined set point, so that any lift generated by air passing over the top of the extended structure walls often called parapets, will actually make all of the wind powered devices involved more efficient, especially during high winds, by actually pulling additional air up through these devices, producing the World's first push-pull wind power system ever conceived, with some of the highest efficiencies ever realized. It is understood, that since all of the energy to operate any wind powered device mounted at the top and/or roof line of a wind energy structure, comes from within the structure; these wind powered devices are to be considered as mounted within the structure. Additionally, with the extended walls often called parapets surrounding the top of said structure and extending approximately as high as a top of said wind powered device; further support is added to the fact that these wind powered devices are to be considered as mounted within the wind energy structure.

Wind powered devices of any applicable number, form, type, size and/or shape could be mounted in multiple channels and/or stages over the height of the structure, or just one at the roof line. Propeller driven wind powered devices could be mounted on swivels within the structure, and/or in any of the channels as desired, including any and/or all of the channels that allow wind to enter the structure. It is understood that any wind powered devices mounted in any of these channels that allow wind energy to enter a structure, are supplied by energy that then enters that structure; these wind powered devices are to be considered as mounted within the structure, even if they protrude from the structure and/or the channels that allow wind to enter the wind energy structure.

These wind energy structures offer the advantage of being built into and among other structures and within our big cities without becoming obtrusive and possibly could even go un-noticed, as they supply the surrounding structures with green energy in the form of electricity and/or the force, motion and/or energy to operate any form of machine ti device imaginable. They will not be inherently unsafe like large propeller driven systems that could come apart and possibly destroy surrounding structures, while injuring or killing people. As there are several existing wind powered devices and/or machine devices that applicant has found that could utilize this green, unlimited and uninterruptable captured wind pressure energy, he has not included apparatus or specific claims on same. The wind energy structure is one of the primary objectives of the patent application at hand, not a specific wind powered device and/or machine device.

With modifications, stairways, elevator shafts and/or other channels within structures could easily be converted into wind energy structures, while still remaining fire sealed from the primary structure they are attached to. Wind energy structures could easily be added onto and/or into existing structures and become a normal addition in new structures, to supply the structure with green energy. Architects, Engineers and Designers could work together on imaginative ways to implement wind energy structures into structures through artistic spires and/or pinnacles, or by simply disappearing them into the normal building structure. They could spiral around new and/or existing structures, and/or just be channels of any size, type, form and/or shape added onto and/or into other structures.

Applicant's calculations also show him that there are times and in special locations where surrounding structures such as other structures and/or topography like mountains and/or trees, that focus the wind into a fairly constant air flow pattern; allow for the addition of unique channels onto and into a wind energy structure that utilize this flow through additional wind powered devices and/or machine devices within the structure. Some could be on swivels within this wind energy structure, to better utilize the wind energy available. With further modifications, this focused wind energy can be concentrated, harnessed and/or utilized through one or possibly several additional channels and/or stages of wind powered devices and/or machine devices, keeping these devices smaller in size and weight. The power generated could be used by the surrounding structures that helped generate this focused green energy, or transmitted into to the electrical power grid. All together, applicant's ideas offers the new, novel, non-obvious, innovative and cost saving advantage of generating green electrical power right where it is needed the most, in downtown urban settings, and within the very structures using it. Eliminating the need for large rural wind farms and the inefficient, extensive and expensive electrical distribution systems required to get the wind generated electrical power into urban settings, where it is needed.

There are many advantages of this type of structure over all previous attempts. Most previous designs for a wind power structure minimize the structure so as to maximize the wind powered device's exposure to wind. Since the energy flow is within the structure, applicant's ideas can easily maximize both the size of the structure and the size and number of the wind powered devices and/or machine devices without any loss of performance or efficiency. Applicant's calculations show that there are no limitations to the number of wind powered devices and/or machine devices employed; their size, or even their combined weight. With his design the structure can simply be made larger and stronger to accept all possible variations, regardless of height, type, shape or size. Plus, applicant's design is the most fatigue failure resistant of any design he ever found throughout his research. His wind energy structures will not suffer from Coriolis force problems, or vibration problems, due to the mass of the structure; making them extremely safe for inter city applications. Applicant shows a square structure in his drawings for simplicity, but any shape, type, size and/or height is possible and it can even narrow or flare out at the top or bottom, or bend around other structures, for architectural appeal. No other current wind power system has all of these combined capabilities.

Applicant took the time to study “wind power” back through 5,500 years of recorded human history and there has never been a single application of any wind power scheme that is anything like what he is teaching. Yes, many civilizations employed wind power to sail for most of that history, but not until around 650 A.D. in what is now called Afghanistan, did man first begin to employ rotational forces with wind power. Since that moment, some 1,360 years ago, not a single scheme has involved a single “method and/or apparatus for utilizing wind energy within a structure” mush less any mention of capturing, channeling, concentrating and/or harnessing the dynamic pressure energy of wind within a structure”, or anything even remotely similar. Some may now say that this is obvious, but it is only obvious because applicant fully describes this new possibility within this patent application, but in practical application, his wind energy scheme is anything but obvious and no one in 5,500 years, ever fully realized how much better it is than anything else ever seen on the surface of the Earth. It must be remembered that it is not whether the differences themselves would have been obvious, but whether the claimed invention at a whole would have been obvious and therefore known and/or used by others.

Yes, for centuries people have opened windows and/or openings in structures to allow cool air/wind into their structures, to remove heat and provide fresh air; which is not in any way comparable to this applicant's claims. All of this prior art is simply using wind as a thermal transport mechanism, but not one single person in the past 5,500 years has ever disclosed or claimed any intent, attempt, strategy, occurrence, scheme, method and/or apparatus to utilize any wind energy within a structure for any reason, as this patent application at hand teaches. Applicant is not trying to cool anything with his ideas, nor is he trying to remove any heat with his ideas, nor is he interested in providing fresh air, for any reason. As pointed out earlier, these prior art uses are not part of the patent application at hand. This is further proof of how new, novel and non obvious his ideas actually are.

Additionally, for most of this same 5,500 years we built structures primarily to protect ourselves from the elements, especially wind. This even continued to the point where it became somewhat ingrained in our DNA to keep wind out of our structures, especially high winds, including PARKER. Which became even more important with structure temperature and humidity control schemes; which is why no one before this applicant ever even imagined utilizing wind energy within a single structure. They were all too busy finding new ways to keep wind out of structures. This has all progressed to the point where most, if not all, building codes now require “wind barriers” on all of our external structure surfaces to prevent wind intrusion, in an attempt to better control structure humidity and temperature. But our structures still leak, especially in high winds as pointed out earlier in this specification. Applicant is the first person to ever stop “resisting” high winds and begin to use these destructive winds to actually save lives, structures and produce mechanical energy and/or electrical power, within a structure.

Applicant did not think that this was possible either, until he risked his life and saw it in operation on his own home during hurricane IVAN. If anyone had thought of the ideas taught within this patent, they would have surely employed them before now, because applicant's mathematical models prove, that his wind power scheme is at least an “order of magnitude” (10 times) improvement over any wind power system currently employed on this Planet and possibly as much as 59 times (5,900%) more efficient than anything ever previously thought of. All those skilled in the art of wind power stopped looking before they got it right. Nothing about this scheme is obvious, especially when Webster's describes “obvious” as “easily discovered, seen, evident, and apparent”. How can anything be considered “obvious” when no one “discovered, saw, or found it to be evident and apparent” at any time before now, during the past 5,500 years? It is because no one before this applicant even thought that this was possible. The only thing that is obvious about what he is teaching through the patent application at hand is that his ideas are truly new, novel and non-obvious.

The only prior art patent that the applicant could find, PARKER, only attempted to let air out of structures through the use of the words “high-pressure surface opening is closed and the low-pressure surface control opening is opened”, which he repeats in this exact form, six times. PARKER never discloses “opening the high-pressure surface opening”; which means that with his scheme the wind impact openings are always closed. He goes onto say “extremely low pressure on the downwind side of the structure causing higher internal pressures inside the structure” twice and only says that “higher” pressures exist inside the structure”. Never does PARKER disclose that any low pressures exist within the structure. This is extremely important. It is well established by Pascal, Bernoulli and even Webster's as stated earlier within this specification that air can only move from areas of high pressure to areas of lower pressure. When all of the above are combined together, PARKER's scheme will only allow air to move from the “higher internal pressures inside the structure” through the opened “low-pressure surface control opening” to the low pressure outside of the structure. PARKER only teaches air moving Out of structures and never teaches anything about air/wind entering a single structure.

Further, PARKER only teaches closing all “high-pressure surface openings”, which will always be on the wind impact surface, thereby totally preventing any air/wind/pressure from entering the structure on any of its “high-pressure surfaces”, as this invention teaches. Additionally, PARKER never discloses even the possibility that wind might be leaking/entering into the structure through this high pressure impact wall. Therefore, all of the prior art, including PARKER, only teaches how to use its “openings” to let air/wind/pressure out of a structure and never teaches how to use a single one of its openings to allow air/wind/pressure to enter a structure. PARKER, and all of the others, had the chance to chose different words, phrases and/or sentences that clearly teach that they wanted air to enter a structure and why, but none of them ever did; and an issue this important cannot now be simply inferred or assumed. None of the prior art, including PARKER, ever discloses any reason, purpose, attempt, strategy, occurrence method and/or apparatus for using wind energy within a structure; so I ask the simple question “why didn't they ever teach allowing wind to enter a single structure?” The simple and truthful answer is “because none of them ever saw any reason to allow wind to enter a single structure”. With applicant's “wind energy structure” air must enter the structure through openings on the structures “high pressure surfaces”, so PARKER's scheme, nor any other scheme in existence, could be used as claimed to produce an unlimited, uninterruptable source of green power, within a structure, as this applicant teaches.

PARKER had not done enough actual structure pressure control work before he filed his patent, to fully understand how pressure moves around within a structure. He missed all of the important issues this applicant is teaching. He totally failed to teach anything about air entering a single structure for any reason! He totally fails to teach anything about adding his “openings” to a single internal surface, within a single structure! He totally failed to teach anything about the how high velocity winds' leaking into structures leaves them at ever increasing high pressures! Instead he wrongly teaches that extreme low pressures outside of the structure leave the structure at a high pressure! He totally failed to teach anything about how air entering the structure provides an unlimited, uninterruptable and free energy/power source! Or how this energy can easily be used to actually strengthen a single structure! Or how it could have been used to operate his “openings”, if he had simply chosen “automatic” openings! Or how this wind energy could be used to operate a single wind powered device within a single structure! Or how this wind powered device could be a wind powered electrical generator within the structure to produce large amounts of electrical power! Or how his scheme is far too slow to ever work when needed! Or how he based his entire scheme on antiquated “static pressure sensors and theory”! Or how his system is based on control theory leaving him at the mercy of external influences and/or human, electrical, computer, control, sensor and/or machine assistance to function! Or how his scheme is not automatic and requires a “trigger” to start; which may or may not occur when needed! Or how his scheme will continue to protect any structure when electrical power fails! In fact PARKER failed to get a single important issue correct, because he cannot teach what he knows nothing about! He totally missed the boat and so did everyone else, so none of them in any way limit the claims presented in the application at hand. Please show me any other patent in the World that teaches the above critical issues, much less a single issue. Applicant looked and never found a single one, before he filed the parent of this application, therefore the broadest claims imaginable should be allowed.

For the past 70+ years, all before this applicant thought that “warm air rising”, or the “buoyancy factors of air” based on Charles's Law (the law of volumes), was the only pressure/energy source that ever occurred within a structure. This is based on warmed air expanding creating more volume resulting in a lighter air mass that rises, while at the same time the colder denser air masses fall, creating what ASHRAE calls a “stack effect” within a structure, and what this applicant calls “stupid”. Applicant was in ASHRAE for over fifteen years and on several of their highest committees and they stopped looking before they got it right. Applicant honestly thinks just about everyone, including ASHRAE, have naively used Charles's Law and the related lie of stack effect, to explain building pressure problems and conditions that they could not otherwise explain, without doing any math to prove their assertions.

CHEN (U.S. Pat. No. 6,798,082) uses this “warm air rising” to power an electrical generator through his disclosure “when air temperature between inside and outside the roof differ, air with high temperature will float to the other space through gaps in turbine blades. Once air is expelled from the room, an in draft cool air from outside of the room will form a warm current, the movement of air in chaotic vertical mass motions because of heating will drive the turbine ventilator to revolve. In addition, seeing that the turbine ventilator is installed at a height of 3 meters, the temperature difference between inside and outside the room is able to form the chimney/stack effect to generate electrical power by revolving the turbine ventilator.” Applicant instead is teaching a practical application of Pascal's Law and Bernoulli equations involving velocity pressure that has almost limitless possibilities. Applicant based none of his calculations on temperature differences, just atmospheric pressure differentials that will drive wind.

Charles's Law and Pascal's Law are two totally different disciplines and cannot be directly compared with each other. Applicant's ideas employing Bernoulli's equations which were derived from Pascal's Law will produce exponentially more electrical power than any system based on “warm air rising”. CHEN employs no air inlets over height as applicant teaches, because he is relying on approximately 90+ degree F. rising heat to spin his turbine, not captured dynamic pressure as applicant teaches. Air inlets over height would have allowed CHEN's trapped heat to escape, defeating his primary stated goal of creating a “chimney/stack effect”. CHEN does disclose “the present invention provides a turbine wind energy generator structure, which has a turbine ventilator with a perpendicular revolving spindle installed to enable wind from any direction to revolve blades.” Now he is employing turbines that turn only when the external edges of the blades are impacted by wind and like everyone else before this applicant; CHEN has now turned his attention to the wind energy on the outside of the structure, from the warm air within the structure. Applicant purposefully keeps the wind from impacting the external edges of the blades of his wind powered devices, because it will hit horizontally mounted wind powered devices evenly on the right and left faces, therefore half the wind energy will try to turn the turbine while the other half of the wind energy will exert a resistance force directly on the turning blades, reducing its efficiency.

CHEN never disclosing a wind turbine that has wind energy flowing up through the center of the turbine and out of its external edges, as the patent application at hand teaches. He only has warm air flowing up through the center of his turbines. This also includes all of those spinning roof turbine vents that you see on homes and other structures. None of them are driven by wind energy from within the structure, as applicant teaches. Instead they are all driven by “warm air rising” and/or wind directly impacting the turbine blades on the outside of the structure. Applicant hereby assert that the only time that Charles's Law could ever generate anywhere near enough pressure within a structure to turn an electrical turbine to efficiently produce electrical power, or push air through a single fire sealed floor of a single standard high rise structure as ASHRAE asserts, is when the structure is on fire. A sad fact is that once ASHRAE has “decided” on what pressure forces exist within a structure, the truth then becomes irrelevant, right along with anyone speaking it. Applicant would love to see ASHRAE or anyone else, do just a little math and try to prove him wrong. It is a clear example of those “skilled in the art”, refusing to be open to new ideas.

Applicant hereby declares that he reviewed every patent he could find concerning wind structures and every single one of the prior art inventors only looked outside of structure for the sources of power to propel their wind driven systems. They stopped looking before they got it right. Their myopic view of wind energy left them all without a clue as to what could happen within a structure. Before this applicant, all those skilled in the art of wind power just saw wind as a straight/inline moving air mass and failed to analyze how its pressure can easily be captured and/or channeled in any direction, even at right angles to the wind direction, through any number of additional channels, and then concentrated and/or harnessed, only within a container, such as a structure. Which is why every patent the applicant reviewed during his research for this specification concerning wind structures, had the wind generator gathering energy either by sitting on a structure, sitting beside a structure, or using scoops, funnels, sails or other similar devices mounted to structures, to enhance their wind energy capture capabilities.

The only true way to design a highly efficient wind powered systems is by viewing wind primarily as a pressure force. The applicant knew that once wind pressure is captured within a container/structure it will constantly strive to reach equilibrium within that container/structure and that the mathematics supporting Pascal's Law and Boyle's Law proves that all contained/captured pressures constantly seek to escape their captivity and reach equilibrium with the universe. This critical information combined with the applicant's intricate knowledge of structure pressures, allowed him to see what no one before him had ever seen, exactly how wind energy pressure can be captured, channeled, concentrated and/or harnessed within a structure. This is the information that makes his wind energy structure, new, novel and non obvious.

All one needs to do is provide the captured wind pressure with a channel of least resistance to escape the structure through any number, type and/or size of properly designed such channels. Since Pascal's Law teaches us that a captured pressure exerts an equal force in all directions, these channels can run in any direction imaginable, even in circles, within the structure, and/or allowing the wind energy structures themselves to run in any direction imaginable, even around the outside of other structures and/or topography. Additionally, there can multiple horizontal channels, multiple vertical channels and/or multiple channels that can literally run in any direction imaginable and/or dynamic wind pressure energy structures themselves that can also literally run in any direction imaginable.

Then one just needs to add any number and type of wind powered devices and/or wind powered electrical generators imaginable to theses channels and/or structures so that the escaping pressure can perform work and transform its pressure energy into mechanical energy and/or into electrical energy, as desired, on its way out of the structure. Therefore, it is actually the same principal that does the work within the applicant's scheme to protect a structure from high winds; that also does all of the work within the applicant's dynamic wind pressure energy structure scheme. This energy is green, free, unlimited and uninterruptable and constantly renewing itself. Applicant's analysis of all current wind powered devices leaves him knowing that the best wind powered device for use within these wind energy structures, has yet to be invented, but he currently lacks the aerodynamic expertise to move the skill level forward and pressure mathematics is his chosen field. The best design would be easy to repair and maintain; while possibly employing back up devices that could offer standby capabilities and/or even spare capacity as needed and/or desired. The primary device could be taken off line for servicing as the standby device is activated allowing for uninterrupted service.

Applicant's preliminary energy and economic calculations reveal that once these wind energy structures are capitalized, in periods as short as three years, they could produce electrical power for around a penny per kilowatt. His further preliminary economic calculations show that this could in turn drive gasoline prices down to around $2.00 per gallon; while finally making electric vehicles truly non-polluting and extremely economical to operate. Wind energy structures could become common in all parking lots and elsewhere, ready to recharge totally electric vehicles, whenever and wherever possible. No one before the applicant ever saw “A method and apparatus to utilize wind energy within a structure” as applicant teaches, or how “to channel said dynamic pressure energy through one or more channels running in any imaginable direction”. So, they could surely never teach how “to harness said dynamic wind pressure energy within the structure”. They all totally fail to teach anything about how velocity pressure can become a captured dynamic pressure and manipulated as desired, once it is contained/captured within a structure, or how it can become much more powerful over height once it is concentrated within the structure. They cannot claim what they know nothing about.

As proof, please provide a single patent that allows wind energy to enter and/or concentrate within a structure; which would disallow applicant's claim 7. Then please provide a single scheme that allows wind energy to be channeled within a structure; which would disallow applicant's claims 7-14. Please provide a single patent that provides any type or form of wind powered device and/or wind powered electrical generator, within a structure to harness this wind energy; which would disallow applicant's claims 16-17. Please provide a single patent that goes on to connect these wind powered device mounted within structures, with a single machine device; which would disallow applicant's claims 18-21. Applicant never found a single scheme or patent that teaches any of the capabilities of this invention. He has waited for over five years for the USPTO to produce a single one. Once again, this proves how new, novel and non-obvious applicant's scheme is and why he deserves approval of the broadest claims imaginable. Applicant respectfully request, please, no more conjectures, no more vague assumptions, no more mislabeling existing patents as “automatic” when they clearly are not, while inferring they have capabilities that they are totally incapable of producing, just pure, honest, truthful, proof, please. All this unnecessary confusion wastes needless time and money, both for this applicant and the tax payers of America. Applicant deserve that clarity finally be brought to all of these important issues, after five years. It is very difficult to be on this end of this situation. Over 500 Americans died due to tornadoes this year alone, plus over 10,000 structures were destroyed, isn't it time these ideas were put to practical application. Gentlemen, can we please work out our differences and stop “fiddling” while Rome burns. It must be remembered that it is not whether the differences themselves would have been obvious, but whether the claimed invention at a whole would have been obvious and therefore known and/or used by others. There is nothing like this invention, in this World.

The Law of Conservation of Energy teaches us that “energy can neither be created nor destroyed; it can only be transformed from one state to another”. When large numbers of wind energy structures as claimed by the applicant are appropriately deployed in and/or around cities, for the first time in recorded history, humans could actually reduce the destructive force of hurricanes and tornadoes by transforming approximately 30% of the available wind energy into mechanical energy to produce electrical power. A destructive 140 mph wind could be reduced to a survivable 98 mph wind, while producing vast quantities of electrical power as a byproduct. Please show me another single theory in existence today that has this ability.

The large propeller driven wind generators that everyone is familiar with are far more prone to destruction by high winds that applicant's systems, due to Coriolis forces, cyclic stresses and gyroscopic precession; dramatically robbing them of efficiency. Plus their blades purposefully deform to prevent destruction in high winds, further reducing efficiencies. The efficiencies of applicant's wind power theories never decrease in high winds and his calculations show that his dynamic wind energy structures can easily handle over 200 mph winds, without any loss of performance. No prior art wind power scheme can handle strong winds, much less produce power in winds over 80 mph, and right up to around 240 mph. Most large propeller driven systems cannot even begin to produce electricity until the wind reaches around 8.0 mph, while applicant's scheme can begin to produce electricity in winds as low as 1.0 mph, due to its ability to concentrate the wind energy over the height of his wind energy structure.

Applicant's preliminary Wind Power Density calculations before and after a large propeller wind “farm” reveals only about a 1-4 percent Wind Power Density decrease/transformation (into mechanical energy/electrical power), which is the true efficiency of these wind “farms”. They do gather Wind Power over height as applicant's scheme does, but only as wind impacts the individual blades and their blades only cover about 8% of the rotational area at any given instant, and their blade efficiencies are not 100%. While applicant's theories allow for the capture of around 70-85%+ of the available Wind Power Density over the entire height and width of his structure, which can be much higher than the standard 300 foot height maximum for propeller driven wind power systems. Then this increased wind energy can be diverted into many channels and/or stages, where it is first concentrated and/or then harnessed and/or then utilized to power many wind devices and/or mechanical devices per structure. Applicant's preliminary calculations also reveal that a similar number of his systems applied in a “farm” type installation, at the same overall height as the propeller driven “farm” systems, will reveal a Wind Power Density decrease/transformation of around 25-65 percent. This translate into the fact that the “maximum effect or nameplate/nominal capacity” of wind powered systems that employ applicant's “dynamic wind energy structures” will be at least ten times greater than any current wind powered generation system in existence. Therefore, applicant's ideas represent at least “an order of magnitude” improvement, in wind powered electrical generation, and some calculations revealed a 59 times increase in efficiency in winds over 60 mph because propeller driven systems purposefully decrease their efficiencies in high winds or totally stop operating, to avoid destruction.

Additionally, these large propeller driven systems must be sighted/installed five rotor diameters apart, in all directions, to prevent loss of performance and turbulence damage. The average large propeller driven wind generator has a rotor diameter of approximately 230 feet, so they have to be sighted/installed at least 1,150 feet from each other, in all directions. How could such spacing ever hope to reduce the force of storm winds, especially when they are only 1-4% efficient? Applicant's wind energy structures can be any geometric shape, size or height imaginable and mounted right next to each other, and/or in a staggered row scheme employing sophisticated mathematical modeling concerning row offset, placement and separation, that funnels and directs the available wind energy smoothly into the second row of applicant's wind energy structures; actually allowing them to produce even better performance efficiencies than the first row. Assuring the maximum amount of Wind Power decrease/transformation with very little wind bypass, while still allowing for almost 360 degree exposure to varying wind directions. Applicant is currently exploring this modeling. Current mathematical results show that only two rows are required, with each row containing as many individual dynamic wind energy structures as desired; which means they could run for miles and miles if required and/or desired. Then another two rows could be deployed every few miles or so, based on the Wind Power Density encountered. Or possibly encircle large cities to power them and protect them from hurricanes and/or tornadoes.

This is the clearest applicant can make the point that his ideas are truly new, novel and non-obvious and can transform much more deadly and destructive high winds, into survivable winds, mechanical energy and/or electrical power, than any conceived system on the face of the Earth. When large numbers of applicant's systems are deployed around and it large cities and even smaller coastal cities, for the first time in the history of man, we will not be totally at the mercy of Mother Nature. We will be able to transform large amounts of the winds from hurricanes and tornadoes into a usable form, such as but not limited to mechanical energy and/or electricity, as applicant knows was intended all along. This excess, inexpensive power could be funneled into the power grid for use by remote cities and industrial manufacturing. If anyone before the applicant had ever imagined what he is teaching, then you would see thousands of his “dynamic wind energy structures” in operation this very minute. But you see none, proving once again how new, novel and non-obvious applicant's ideas actually are.

In winds above 60 mph, the applicant's scheme is the only wind power scheme ever imagined that can keep on operating right up to winds above 200 mph, with appropriately sized and located weather resistant pressure relief valves; while still maintaining approximately the same 25-65% efficiencies, in properly designed and constructed wind energy structures. Please point out another scheme that can do this. After running many mathematical calculations, applicant hereby asserts that if the strong tornadoes that struck the American Southeast in April 2011 along with Oklahoma and Joplin, Mo. in May, had encountered a single double row set of his dynamic wind pressure energy structures along their paths, the 200 mph winds could have been reduced to around 150 mph; with far fewer lives lost and many more structures left standing. If two double row sets of his dynamic wind pressure energy structures had been encountered, this 150 mph wind could have been further reduced to around 110 mph, or the vortex disrupted and these tornadoes would not be the news story they continue to be.

Additionally, if many of the homes involved, had the applicant's automatic, self regulating, high wind, structure protection scheme built into them as taught in this patent application at hand, the families involved could have safely sheltered in place and the whole event may not have even made the evening news and the current victims might have only had to perform light repairs and clean up their yards, instead of having to start all over again. Further, these same tornadoes could have been seen as somewhat of a blessing as they generated vast quantities of inexpensive and green electrical power for the very communities, that were instead devastated. All of this destruction occurred while Japan has almost been destroyed by the curse of nuclear power and still no one knows exactly how to deal with nuclear waste. The Worldwide pollution associated with mining and burning coal makes it a poor energy alternative. Applicant would love to be part of any idea that breaks the death grip OPEC has on the throats of all Western economies, so that all of the economies of the World will be equally based on “value added”; and economies based on the “gift of oil” can finally become a footnote in history.

Another unique vision applicant has for these wind energy structures is of a structure of unlimited size and shape with a simple, strong, and repairable steel, plastic, wood, etc. skeletal structure with an inexpensive and easy to install membrane covering. This membrane would allow air to enter from one side of the membrane through molecular and/or micro pore “channels” etc., and then into the structure. This membrane would also have the unique ability to seal itself and prevent the loss of any captured wind energy through the opposite side of the same membrane. So once again, wind energy coming from any direction, is first captured by the membrane, then channeled into any number and/or size of channels running in any imaginable direction, then concentrated over height and then harnessed into mechanical energy, all within the structure.

This is part of applicant's reasoning behind using the word “channel” in his claims concerning wind energy structures. Applicant is currently in the process of contacting several manufacturers of wind membranes concerning this unique one-way air movement. Applicant hereby declares that he has never seen a membrane, or structure with these abilities. Applicant envisions many Military, Emergency and Disaster Area uses for this inexpensive and easy to erect wind energy structure that can be compactly stored and ready for immediate deployment. It could become the most widely deployed Third World wind power system. The membrane could have a “tear away” ability that allows it to disintegrate in high winds, so as to protect the underlying structure. Maintenance would be simple as the membrane could have the ability to be easily field repaired, and/or discarded after several uses when damaged, or when it is tattered and then replaced with a new one. Several of these unique dynamic pressure structures could be deployed together to satisfy any possible mechanical energy/electrical demand load.

So, even though buildings are emphasized in this patent, it is understood that the same principles of protecting a single pressure vessel during high winds and/or constructing a wind energy structure could easily and effectively be applied to any structure, whether commercial, military, governmental, industrial and/or residential, even high rise structures, regardless of size, shape, and/or number of floors involved. Other aspects of the invention are more fully disclosed hereafter. While preferred embodiments have been described, it will be appreciated that other modifications, adaptations and changes to the invention will be readily apparent to those skilled in the art.

### DESCRIPTION OF THE DRAWINGS

FIG. 1 is a cross section view of a structure with at least one external surface and at least one internal surface within an internal area that has at least one external surface separating this internal area from an outside; illustrating the sealing of all the attics, roof cavities working and/or living spaces to all surrounding areas, except each other, through the implementation of a sealed external surface, including an illustration of the placement of pressure transfer openings and/or pressure relief valves in internal areas such as but not limited to, attics, rooms, floors and/or ceiling cavities, floor cavities, wall cavities and/or any and all interstitial areas, etc., within the structure, to form the single pressure vessel that will operate at a uniform pressure and allow pressure to easily, automatically and quickly equalize within all of the areas to be protected. Also illustrated is a weather resistant pressure relief valves to outside at the external surface of all internal areas of the single pressure vessel. This FIGURE provides a clear illustration of how the external surface of the internal areas of the single pressure vessel can be the external surface of the structure.

FIG. 2 is a cross section view of a structure with at least one external surface and at least one internal surface within an internal area that has at least one external surface separating this internal area from an outside; with sealed attics and/or roof cavities illustrating the sealing of attached, enclosed, structures to all surrounding areas, through the implementation of a sealed external surface, except each other and the structure core itself, including pressure transfer openings and/or automatic, pressure relief valves between these various attached and now internal areas within the structure, to form the single pressure vessel that will operate at a uniform pressure. FIG. 2 also includes an illustration of the placement of pressure transfer openings and/or pressure relief valves in internal areas, such as but not limited to, attics, rooms, floors and/or ceiling cavities, floor cavities, wall cavities and/or any and all interstitial areas, etc. . . . , within the structure, to form the desired single pressure vessel and allow pressure to easily, automatically and quickly equalize within it. Again, an illustration is included of weather resistant pressure relief valves to outside located at the external surface of all internal areas of the single pressure vessel. This FIGURE provides another clear illustration of how the external surface of the internal areas of the single pressure vessel can be the external surface of the structure.

FIG. 3 is a cross section view of a new or existing structure with at least one external surface and at least one internal surface within an internal area that has at least one external surface separating this internal area from an outside; with attics and/or roof cavities that cannot be sealed to outside, illustrating the installation of pressure relief valves between the sealed internal areas and the unsealed attic area and/or unsealed roof cavity, at the external surface of all internal area of the single pressure vessel and thereby to outside. It includes an illustration of the placement of pressure transfer openings and/or pressure relief valves in internal areas such as but not limited to, attics, rooms, floors and/or ceiling cavities, floor cavities, wall cavities and/or any and all interstitial areas, etc, to form the desired single pressure vessel that will operate at a uniform pressure. Also included is an illustration of weather resistant pressure relief valves to outside, located at the external surface of all internal areas of the structure; which is the top floor ceiling. Additionally illustrated is a weather resistant pressure transfer opening and/or a weather resistant pressure relief valve to outdoors, located at the external surface of the structure itself. This FIGURE provides a clear illustration of how the external surface of the internal areas of the single pressure vessel is not always the external surface of the structure.

FIG. 4 is a cross section view of a multi-floor, high rise structure with at least one external surface and at least one internal surface within an internal area that has at least one external surface separating this internal area from an outside; illustrating the sealing of all internal areas, such as but not limited to, the rooms, floors, attics, roof cavities working and/or living spaces to all surrounding areas, except each other, through the implementation of a sealed external surface including an illustration of the placement of pressure transfer openings and/or pressure relief valves in internal areas, such as but not limited, to, attics, rooms, floors and/or ceiling cavities, floor cavities, wall cavities and/or any and all interstitial areas, etc., within the structure, to form the single pressure vessel that will operate at a uniform pressure and allow pressure to easily, automatically and quickly equalize within all of the areas to be protected. Also included is an illustration of weather resistant pressure relief valves to outside located at the external surface of all internal areas of the single pressure vessel. This FIGURE illustrates how the external surface of the internal areas of the single pressure vessel can be the external surface of the structure.

FIG. 5 is a cross section view of a wind energy structure with an internal area with at least one external surface separating this internal area from an outside; that has little or minimal internal obstructions that could impede the flow of dynamic pressure, illustrating the installation of channels on all sides that could possibly receive wind to allow wind pressure energy to be captured within the structure. Wind will increase in velocity over the height of the structure, so more openings may be employed. More openings could be applied to the lower floors if desired. This drawing clearly shows how channels can be employed within the structure to channel, concentrate and/or harness this captured wind energy through the implementation of any size, type or number of wind powered devices, and/or wind powered electrical generators; which can then be connected with any size, type and/or number of machine devices. This simple illustration includes the placement of a vertical flow wind powered device that happens to be a wind powered electrical generator at or near the roof line but still within the structure, along with several other stages of wind powered devices within the structure. Thus, more than one wind powered device can be applied over the height of the structure. Also included is a wind powered electrical generator within one of the channels that allow wind to enter the structure. Propeller driven units could be employed, including but not limited to within the channels that allow wind to enter the structure, on swivels within the structure, and/or elsewhere. The structure can be of any size, type, height and/or shape desired.

### DETAILED DESCRIPTION OF THE INVENTION

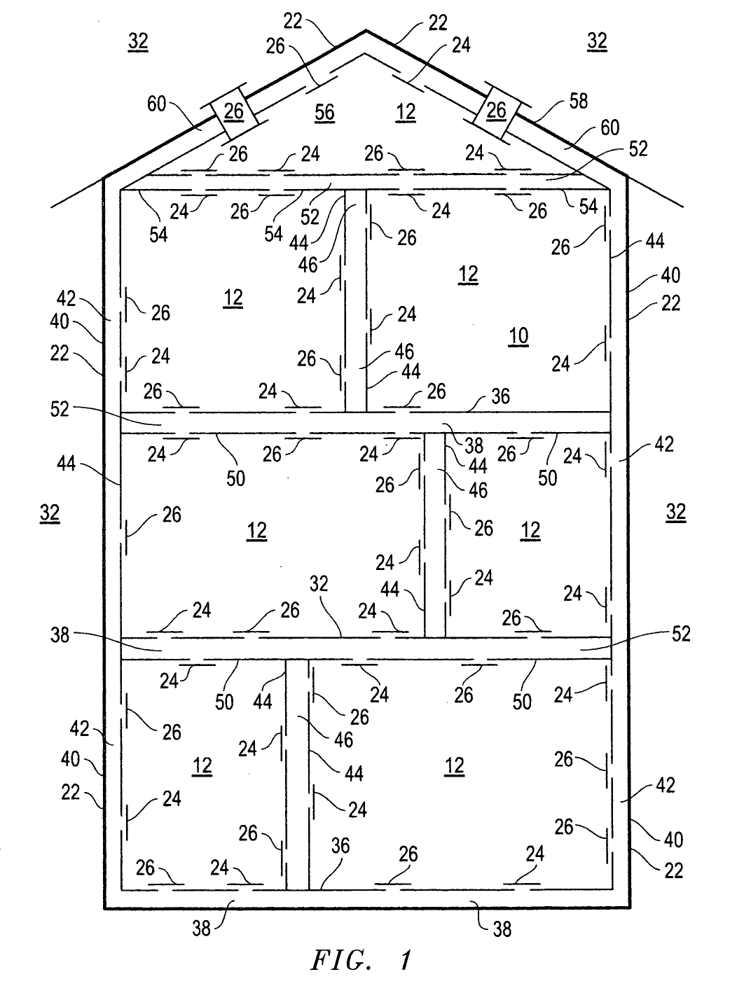

An embodiment of the present invention is illustrated by way of example in FIGS. 1-4. With specific reference to FIGS. 1, 2 and 4, a single pressure vessel 12, a new or existing structure 10, that have sealed attics 56, and/or sealed roof cavities 60, that are not ventilated/opened to outside 32. According to one embodiment the present invention includes, in a structure 10, with single or multiple floors (shown but not numbered), floor surfaces 36, floor cavities 38, ceiling surfaces 50, ceiling cavities 52, external wall surfaces 40, external wall cavities 42, internal wall surfaces 44, internal wall cavities 46, sealed attic 56, attic ceiling surfaces 54 and rooms (shown but not numbered). The sealed external surface 22 is shown with a thick black line. These three FIRURES provide clear illustrations of how the external surface of the internal area 22 can be the external surface 40 and/or 58 of the structure 10.

This sealed external surface 22 is used to establish the external surface of the single pressure vessel 12. Therefore, all of the internal areas 12 within a single, continuous sealed external surface 22 that are marked 12 are internal areas of the same, single pressure vessel 12. Various possible locations of pressure transfer openings 24 and/or pressure relief valves 26, are shown for example only, and not by way of limitation, to allow pressure to easily, automatically and quickly equalize between all of the internal areas of the single pressure vessel 12. Such as but not limited to, through floor surfaces 36, floor cavities 38, through ceiling surfaces 50, ceiling cavities 52, external wall cavities 42, through internal wall surfaces 44, internal wall cavities 46, sealed attic 56, through attic ceiling surfaces 54, and/or roof cavities 60, rooms (shown but not numbered) and/or floors (shown but not numbered), of the structure 10. Any location of pressure transfer openings 24 and/or pressure relief valves 26 that is desired and/or appropriate may be used.

FIG. 1 clearly illustrates the formation of a single pressure vessel 12, in a new or existing structure 10, that has a sealed attic 56, or sealed roof cavity 60, that is not ventilated/opened to outside 32, by establishing the external surface 22 of the single pressure vessel 12 with a thick black line, through the implementation of sealed external surface 22. This along with pressure transfer openings 24 and/or pressure relief valves 26, are done so that all of the internal areas 12 to be protected, such as but not limited to, through floor surfaces 36, floor cavities 38, through ceiling surfaces 50, ceiling surfaces 50, ceiling cavities 52, external wall cavities 42, through internal wall surfaces 44, internal wall cavities 46, sealed attic 56, through attic ceiling surfaces 54, roof cavities 60, rooms (shown but not numbered) and/or floors (shown but not numbered), of the structure 10, can easily communicate with each other throughout the single pressure vessel 12 and allow pressure to easily, automatically and quickly equalize between one another, and all of the internal areas of the entire single pressure vessel 12 and not outside 32. The sealed external surface 22 prevents the protected internal areas 12 within the structure 10 from uncontrollably communicating with outside 32. There are times where this sealed external surface 22 of the internal areas of the single pressure vessel 12, may not always be the external surface 40 and/or 58 of the structure 10 due to construction methods that place unprotected areas (not shown) that are not part of the single pressure vessel 12, between the internal areas 12 and the external surface 40 and/or 58 of structure 10. This situation is described with language such as “the external surface 22 of the internal areas 12” and/or “the external surface 22 of the single pressure vessel 12”. This FIGURE provides a clear illustration of how the external surface 22 of the internal areas 12 can be the external surface 40 and/or 58 of the structure 10.

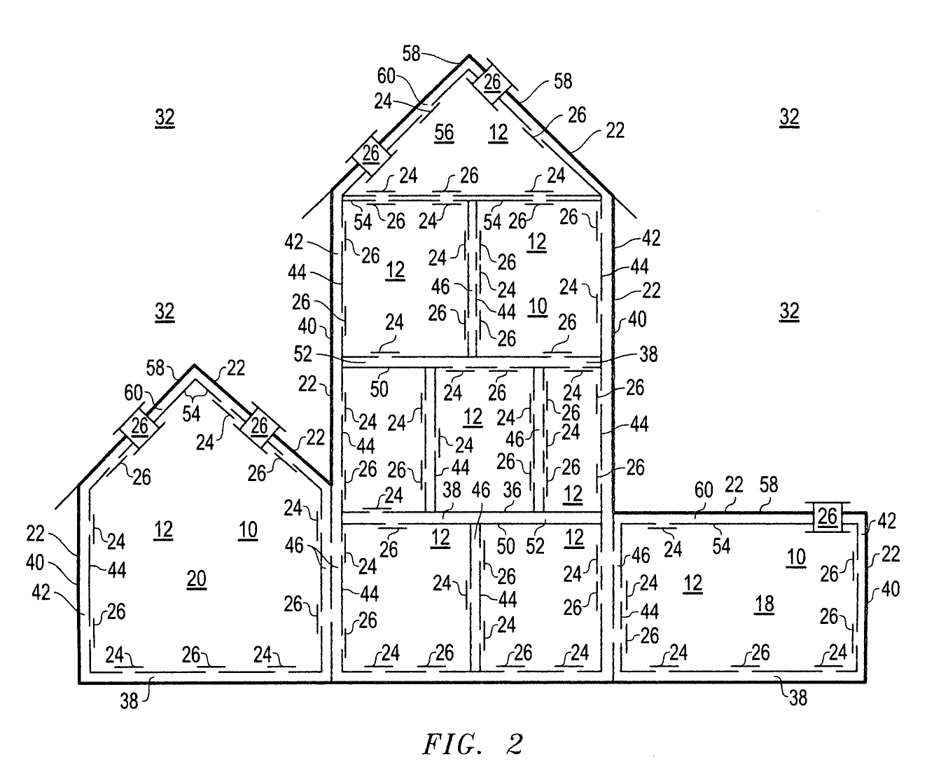

According to one embodiment, FIG. 2 includes the addition of two attached, enclosed structures 14, that are to be included in the single pressure vessel 12, of a new or existing structure 10, that has a sealed attic 56, or sealed roof cavity 60, that is not ventilated/opened to outside 32. The sealed external surface 22 is now extended to include structures 14. Therefore, all of the internal areas 12 within a single, continuous external surface 22 that are marked 12 are parts of the same single pressure vessel 12. For example only, and not by way of limitation this drawing includes a garage 18, on the right side of the structure 10, and an enclosed swimming pool area 20, on the left side of the structure 10. Refer again now to FIG. 2, for a more complete description of the variety of possible locations for pressure transfer openings 24 and/or pressure relief valves 26. These locations are shown for example only, and not by way of limitation, to allow pressure to easily, automatically and quickly equalize between all of the internal areas of the single pressure vessel 12, of a new or existing structure 10, that has a sealed attic 56, or sealed roof cavity 60, that is not ventilated/opened to outside 32. Such as but not limited to, through floor surfaces 36, floor cavities 38, through ceiling surfaces 50, ceiling cavities 52, external wall cavities 42, through internal wall surfaces 44, internal wall cavities 46, sealed attic 56, through attic ceiling surfaces 54, roof cavities 60, rooms (shown but not numbered) and/or floors (shown but not numbered), of the structure 10.

Any location of pressure transfer openings 24 and/or pressure relief valves 26 that is desired and/or appropriate may be used. Please note that when pressure transfer openings 24 and/or pressure relief valves 26, are installed in an external wall cavity 42, they are only installed on the internal wall surface 44, of this cavity 42 that faces, opens up to, the single pressure vessel 12. The external wall surface 40 is the one that is closest to the outside 32. Neither this external wall surface 40, nor its sealed external surface 22, are ever pierced by anything except required openings (not shown), windows (not shown), and/or doors (not shown) that are then sealed in place. In fact, under no circumstances is the sealed external surface 22 ever pierced, except by required openings (not shown), windows (not shown), and/or doors (not shown) that are then sealed in place, as well as possible, or by weather resistant pressure relief valves 26, to outside 32, that are installed on all roof surfaces 58, in order to easily, automatically and quickly relieve pressure build ups within the structure 10, to outside 32, at the external surface of the structure 22. This FIGURE provides a clear illustration of how the external surface 22 of the internal areas 12 can be the external surface 40 and/or 58 of the structure 10.

Stairways (not shown) in a normal multiple floor (shown but not numbered), new, or existing structure 10, that has a sealed attic 56, or sealed roof cavity 60, that is not ventilated/opened to outside 32, will serve as a perfect self regulating, automatic, pressure operated, pressure transfer openings 24, between the various floors (shown but not numbered). When this is true, then the pressure transfer openings 24, and/or pressure relief valves 26, that are mounted on ceiling surfaces 50, of the various floors (shown but not numbered), will only pierce the ceiling surface 50, and allow pressure to be automatically and easily released from the ceiling cavity 52. If there is no stairway (not shown), or if for some reason, the stairway (not shown) is sealed, or has some other form of restriction, then some of the ceiling surface 50 mounted pressure transfer openings 24 and/or pressure relief valves 26, will need to be installed on both the ceiling surface 50 and the floor surface 36 above the ceiling cavity 52, so that pressure can easily and automatically equalize between the multiple floors (shown but not numbered) involved, and easily escape the ceiling cavity 52. Sometimes a floor cavity 38 from one floor (shown but not numbered) and a ceiling cavity 52 from the floor (shown but not numbered) below, can be the same cavity 38 or 52, and can be called either or both.

According to anther embodiment of the invention, FIGS. 1, 2 and 4 also illustrates how weather resistant pressure relief valves 26 to the outside 32, that pierce the sealed external surface 22, at the roof surface 58, may be added to relieve built up pressures from within the single pressure vessel 12 of a new or existing structure 10, that has a sealed attic 56, or sealed roof cavity 60, that is not ventilated/opened to outside 32, that occur during any and all wind and pressure challenges. These FIGURES provide a clear illustration of how the external surface 22 of the internal areas 12 can be the external surface 40 and/or 58 of the structure 10. These roof 58 mounted weather resistant pressure relief valves 26, to outside 32, are the only time that the sealed external surface 22 is pierced, other than for required openings (not shown), doors (not shown), and/or windows (not shown), and these should then be sealed in place, as well as possible. Due to the high winds involved, external wall surfaces 40, are not a suitable location for these pressure relief valves 26, as deployed by previous patents. The aerodynamic forces of high winds on a pressure relief valve 26, located on an external wall surface 40, or on only one side of a sloped roof surface 58, could easily prevent it from operating at the proper relief pressure, when needed. The same does not hold true for flat roof surfaces 58, or sloped roof surfaces 58 that are not in the direct path of the wind, due to the well know pressure envelope, that develops over roof surfaces 58. So, for proper operation and protection, the weather resistant pressure relief valves 26, which open to outside 32, must be located on roof surface 58.

So, if the roof surface 58 is sloped, weather resistant pressure relief valves 26 should be installed on all of the sloped sides of the roof surface 58. So, in other words, every slopped roof surface 58 should have at least one weather resistant pressure relief valve 26, installed on it. This will allow a pressure envelope to develop over at least one of the weather resistant pressure relief valves 26 to allow it to operate properly during high winds. Individual flat roof surfaces 58 and individual sloped roof surfaces 58 can each have a few as one weather resistant pressure relief valves 26, provided it is sized and located properly. More than one weather resistant pressure relief valves 26 can be used on each of these roof surfaces 58, if desired. The weather resistant pressure relief valves 26 can be located anywhere on the roof surface 58 that is desired, or appropriate, as long as it is sized properly and can easily communicate with the single pressure vessel 12.

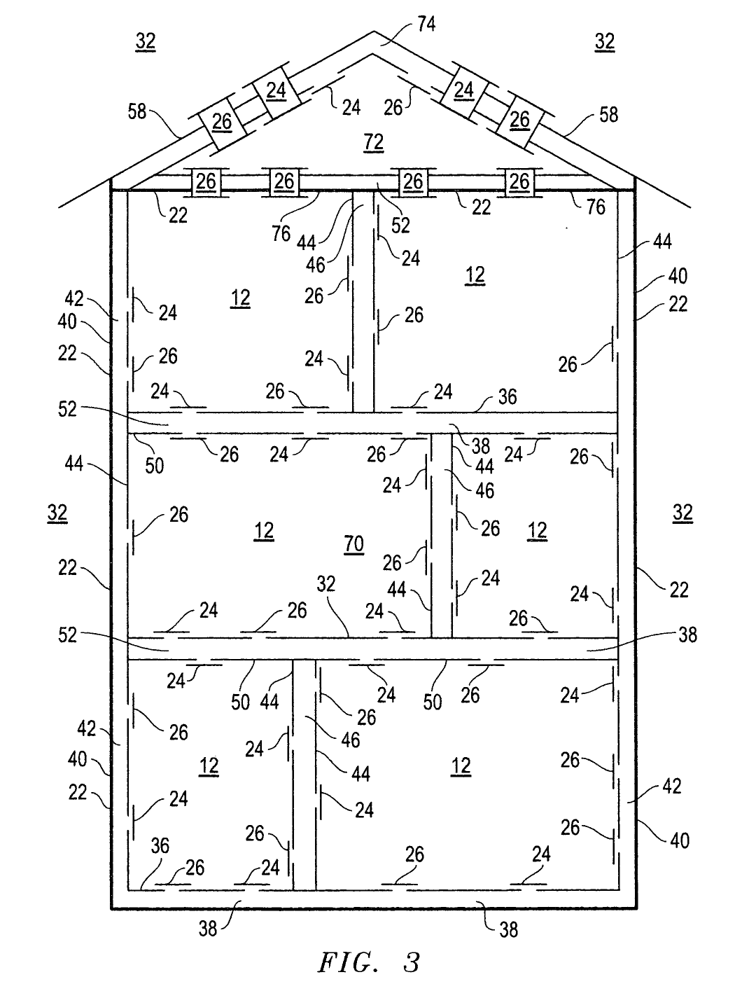

Due to the way that some new or existing structures 70 are constructed with attics 72, roof cavities 74 and/or any other areas that cannot be sealed to outside 32, applicant feels that it will be difficult, but not impossible to create a sealed external surface 22 and convert them to the above described single pressure vessel 12. FIG. 3 is another embodiment of the invention that illustrates how weather resistant pressure relief valves 26, can be added to the external surface 22 of the single pressure vessel 12 as shown with a thick black line, in a new or existing structure 70; which in this case are the ceiling surfaces 76 just below the unsealed attic. This will allow pressure to be released from the internal areas of single pressure vessel 12, into the unsealed attic 72, roof cavities 74 and/or any other unsealed areas, at this external surface 22 of all internal areas of the single pressure vessel 12 and thereby to outside 32, before an uncontrolled catastrophic explosive pressure release occurs. Pressure transfer openings 24 should not be used at these locations as they could allow humidity to uncontrollably enter into internal areas 12. Any location of the weather resistant pressure relief valves 26, on ceiling surfaces 76 that is desired and/or appropriate, may be used. Weather resistant pressure relief valves 26 can also be added to the roof surface 58 of these unsealed attic 72, roof cavities 74 and/or any other unsealed areas to readily, automatically and easily relieve pressure to outside 32. Since moisture intrusion is not a concern here weather resistant pressure transfer openings 24 could also be used.

Refer again to FIG. 3, for a more complete description of another embodiment of the invention, for a variety of possible locations for pressure transfer openings 24 and/or pressure relief valves 26, in new or existing structure 70 that have attics 72 and/or roof cavities 74 that cannot be sealed to outside 32. Pressure relief valves 26 locations are shown for example only, and not by way of limitation to allow pressure to easily equalize between all of the internal areas of the single pressure vessel 12 of the new or existing structures 70 such as but not limited to, floors (shown but not numbered), through floor surfaces 36, floor cavities 38, through ceiling surfaces 50, ceiling cavities 52, external wall cavities 42, through internal wall surfaces 44, internal wall cavities 46, rooms (shown but not numbered), before an uncontrolled catastrophic pressure release occurs. Therefore, all of the internal areas 12 within a single, continuous surface 22 that are marked 12, are parts of the same single pressure vessel 12. Pressure transfer openings 24 and/or pressure relief valves 26 can be located as desired and/or where appropriate.

Again, pressure relief valves 26 will prevent the uncontrolled entrance of humidity into the internal area of the single pressure vessel 12 of the structure 70, where pressure transfer openings 24, could allow humidity to enter and move throughout the structure 70, uncontrollably, and cause considerable mold, mildew and/or rot problems. As mentioned above, it could be difficult, but not impossible to establish the external surface 22 of the single pressure vessel 12 as shown with a thick black line, through the implementation of a sealed external surface 22 and convert new or existing structures 70 into the above described single pressure vessel 12. Or they can just be modified as best as possible with pressure transfer openings 24 and/or pressure relief valves 26.

Please note that when pressure transfer openings 24 and/or pressure relief valves 26, are installed in an external wall cavity 42, they are only installed on the internal wall surface 44, of this cavity 42 that faces, opens up to, the single pressure vessel 12, of a new or existing structure 70. The external wall surface 40 is the one that is closest to the outside 32. Neither this external wall surface 40, nor its sealed external surface 22, if installed, are ever pierced by anything except required openings (not shown), windows (not shown), and/or doors (not shown) that are then sealed in place. In fact, if a sealed external surface 22 is created on a new or existing structure 70, then under no circumstances is the sealed external surface 22 ever pierced except by required openings (not shown), windows (not shown), and/or doors (not shown) that are then sealed in place, as well as possible, or by the weather resistant pressure relief valves 26, to outside 32 at ceiling surfaces 76 just below the unsealed attic. There are times where this sealed external surface 22 of the internal areas of the single pressure vessel 12, may not always be the external surface 40 and/or 58 of the structure 70, as shown, due to construction methods that place unprotected areas 72 and/or 74 between the internal areas 12 and the external surface 40 and/or 58 of structure 70. This situation is described with language such as “the external surface 22 of the internal areas 12” and/or “the external surface 22 of the single pressure vessel 12”. This FIGURE provides a clear illustration of how the external surface 22 of the internal areas 12 is not always the external surface 40 and/or 58 of the structure 70. “Outside” 32 refers to “all areas of any kind that are beyond any and all of the surfaces 22, 40 and/or 58 as defined and illustrated in FIGS. 1-4”. This figure adds clarity to the fact that, for this invention a single structure 70, and/or structure 10 (as illustrated in FIGS. 1, 2 and 4), may have two “outsides” 32; one “outside” 32 of the single pressure vessel 12 at ceiling surfaces 76 just below the attic and another one that is “outside” 32 of the structure 70 and/or 10 itself at roof surface 58.

Stairways (not shown) in a normal multiple floor (shown but not numbered), new or existing structure 70 will serve as a perfect self regulating, automatic, pressure operated, pressure transfer openings 24, between the various floors (shown but not numbered). When this is true, then the pressure transfer openings 24 and/or pressure relief valves 26 that are mounted on the ceiling surfaces 50, will only pierce the ceiling surface 50, and allow pressure to be easily and automatically released from the ceiling cavity 52. If there is no stairway (not shown) or if for some reason, the stairway (not shown) is sealed or has some other form of restriction, then some of the ceiling surface 50 mounted pressure transfer openings 24 and/or pressure relief valves 26, will need to be installed through the ceiling surface 50 and the floor surface 36 above the ceiling cavity 52, so that pressure can easily escape the ceiling cavity 52 and/or floor cavity 38, and equalize between the floors (shown but not numbered) involved.

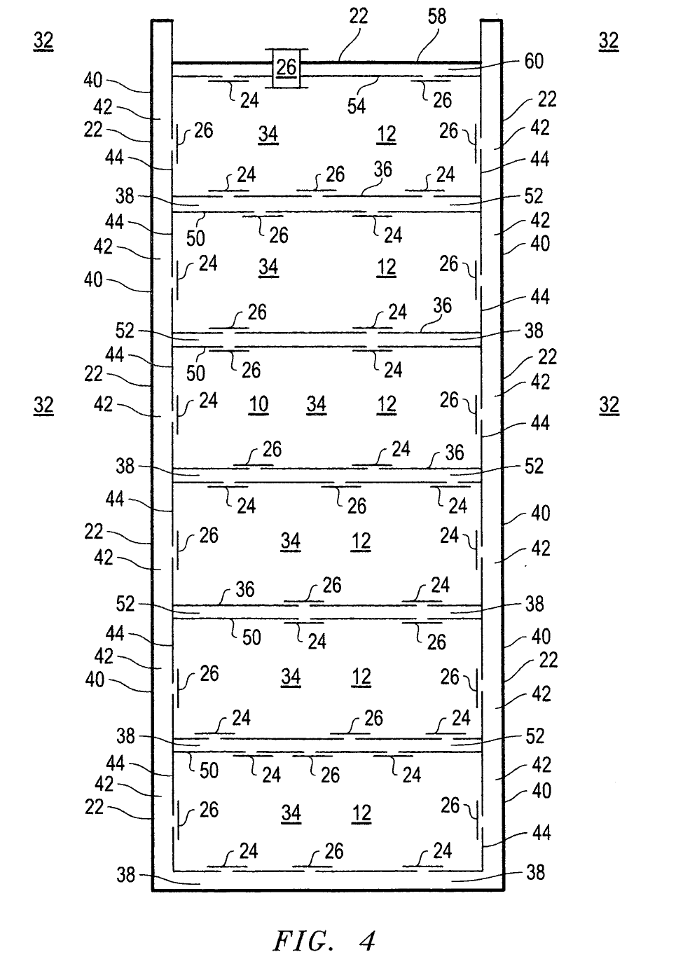

FIG. 4 clearly illustrates a new or existing multiple floor 34, high rise structure 10 that can be of unlimited height and unlimited number of floors 34 and rooms (shown but not numbered). Shown is the formation of a single pressure vessel 12, that has a sealed attic (not shown), or sealed roof cavity 60, that is not ventilated/opened to outside 32, by establishing the external surface 22 of the single pressure vessel 12 with a thick black line, through the implementation of sealed external surface 22. Therefore, all of the internal areas 12 within a single, continuous surface 22 that are marked 12, are parts of the same single pressure vessel 12. This along with pressure transfer openings 24 and/or pressure relief valves 26, are done so that all of the internal areas of the single pressure vessel 12 to be protected, such as but not limited to, through floor surfaces 36, floor cavities 38, through ceiling surfaces 50, ceiling surfaces 50, ceiling cavities 52, external wall cavities 42, through internal wall surfaces 44, internal wall cavities (not shown), sealed attic (not shown), through attic ceiling surfaces 54, roof cavities 60, rooms (shown but not numbered) and/or floors 34, of the structure 10, can easily communicate with each other and allow pressure to easily, automatically and quickly equalize between one another, and all of the internal areas of the entire single pressure vessel 12 and not outside 32. The sealed external surface 22 prevents the protected areas 12 from communicating with outside 32. In fact, under no circumstances is the sealed external surface 22 ever pierced, except by required openings (not shown), windows (not shown), and/or doors (not shown) that are then sealed in place, as well as possible, or by the weather resistant pressure relief valves 26, to outside 32, that are installed on all roof surfaces 58, in order to easily, automatically and quickly relieve pressure build ups within the single pressure vessel 12, to outside 32. This FIGURE provides a clear illustration of how the external surface 22 of the internal areas 12 can be the external surface 40 and/or 58 of the structure 10.

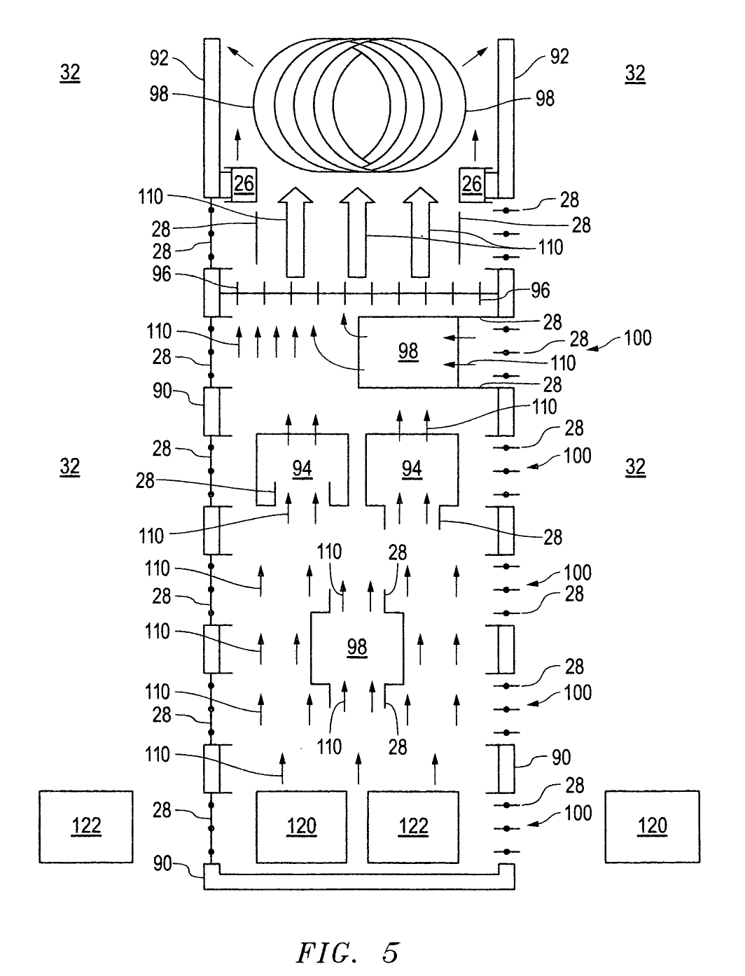

According to anther embodiment of the invention, FIG. 5 illustrates a simplified version of how to implement a dynamic wind pressure energy structure 90. It is understood that structures 90 could be of any type, shape, height, depth, width and/or length imaginable; which are included by reference and inference. The preferred embodiment is a structure that has no or minimal internal obstructions that could impede the wind energy 110 flow, illustrating the installation of channels 28 on all sides that could possibly receive wind 100. More channels 28 can be employed within the structure as shown to channel, concentrate, harness and/or utilize this wind energy 110 through the implementation of any size, type, shape or number of wind powered devices 94 and/or machine devices 120 and/or 122. Please note that the wind 100 is coming from the right hand, therefore all of the channels 28 on that side have moved to open at a predetermined set point, while the channels 28 on all of the other sides have moved to close at a predetermined set point, to capture wind energy 110 and prevent it from leaving the structure 90. It is understood that any type of channels 28, even motorized ones, could be used in this structure 90, since their design is not critical to the implementation of wind energy structure 90 and no previous patent has implemented a structure 90 similar to this. It is further understood that channels 28 can be operated through manual control, automatic operation requiring no external influence and/or assistance and/or control theory operation, and/or any mix, scheme, occurrence, method and/or apparatus thereof, imaginable; and will move to open and/or close at predetermined set points.

Stairways (not shown) can be used to capture, channel, concentrate and/or harness wind energy 110 and for access to the structure 90 they are attached to, as long as landings (not shown) still allow an open channel 28 to exist from the bottom to the top of the wind energy structure 90. Further, existing channels 28 (not shown) within any structure (not shown) can also be converted into wind energy structures 90 as long as an open channel 28 (shown but not numbered) of sufficient length exist within the wind energy structure 90 and additional channels 28 are installed in and on the structure 90; to capture, channel and/or concentrate as much wind energy as possible. For simplicity this illustration includes the placement of a center flow wind powered device 94 that happens to be a wind powered electrical generator 98 at and/or near the roof line (shown but not numbered), along with another stage of wind powered electrical generators 98 mounted in one of the channels 28 that allow wind to enter structure 90, plus another stage of wind powered electrical generator 98 within structure 90 along with two more stages of wind powered devices 94. It is understood that of any size, type, form and/or number of wind powered devices 94, wind powered electrical generators 98 and/or machine devices 120 and/or 122, may be employed to harness the available wind energy 110 within the structure 90. These machine devices 120 and/or 122 can be any applicable device desired; two electrical generator machine devices 122, along with two other machine devices 120, are shown on FIG. 5. It is understood that any number imaginable can be employed with a single wind energy structure 90. The only limitation here is the size, type, shape and/or height of the wind energy structure itself 90, and it can be designed to any size, type, height and/or shape desired or imagined.

It is also understood that more channels 28 can be employed over the height of the structure 90 as wind velocities increase over height. Sometimes more channels 28 may be used on the lower floors (shown but not numbered) than the upper floors (shown but not numbered). The term floor (shown but not numbered) is used to describe any increase in structure 90 height and is not limited to the normal description of a floor (shown but not numbered) of a standard wind energy structure 90. This wind energy flow 110 can further be captured, channeled, concentrated, harnessed and/or utilized through one or possibly several stages of wind powered devices 94 and/or wind powered electrical generator 98; through the addition of more channels 28 as shown within the wind energy structure 90. With further modifications the force, motion and/or energy produced by any wind powered device 94 and/or 98 within structure 90 can be further utilized by connecting them with one or more machine devices 120 and/or 122; mounted within structure 90 and/or machine devices 120 and/or 122 mounted outside 32 of structure 90, as shown, through the addition of belts (not shown), drive lines (not shown) and the like (not shown). It is understood that any applicable form, type, size and/or number of applicable machine device 120 can be employed, even electrical generator machine devices 122 as shown both within structure 90 and outside 32 of it.

Since Pascal's Law teaches us that this captured pressure 110 exerts an equal force in all directions, these channels 28 can run in any direction imaginable, even in circles (not shown), within the structure 90 and/or even on the outside of a structure 90 and/or allowing these wind energy structures 90 themselves to run in any direction imaginable; even around other structures (not shown) and/or topography (not shown). There can be multiple channels 28 that can literally run in any direction imaginable and/or wind energy structures 90 themselves that can also literally run in any direction imaginable. Wind powered devices 94 could be mounted in any channel 28, including channels 28 that allow wind to enter the wind energy structure 90 as shown on the drawings as a wind powered electrical generator 98. It is understood that any wind powered devices 94 mounted in any of these channels 28 that allow wind energy 110 to enter a structure 90, are supplied by energy 110 that then enters that structure 90; these wind powered devices 94 are to be considered as mounted within the structure 90, even if they protrude from the structure 90 and/or the channels 28 that allow wind 100 to enter the wind energy structure 90. It is understood that channels 28 can be operated through automatic operation requiring no external influence and/or assistance and/or control theory operation, and/or any mix, scheme, occurrence, method and/or apparatus thereof, imaginable; and will move to open and/or close at predetermined set points.

Air straightening vanes 96 as shown can be added as desired to assure a smooth entrance flow into any size, type or number of wind powered devices 94 and/or channels 28 to maximize power generation. They would also prevent debris from being drawn into a wind powered device 94 during hurricanes and tornadoes. Applicant's research reveals that wind powered devices 94 mounted at the roof line and/or top of a wind energy structure 90 as shown, should have extended walls 92 often called parapets 92 which describe the same surface, that extend a little higher than a top of the wind powered device 94, as shown, leaving them within structure 90. This will prevent high winds 100 from directly impacting the blades of the wind powered devices 94 mounted at the top and/or roof line (shown but not numbered); which will actually reduce the efficiency of a center flow wind powered device 94. Wind powered devices 94 mounted anywhere within the structure 90 could have channels 28 leading to the top of the structure 90 that will move to open at a predetermined set point so that any lift generated by wind 100 passing over the top of the structure 90 and/or extended walls 92 often called parapets 92 will actually make all of the wind powered devices 94 involved more efficient, especially during high winds 100, by actually pulling more energy 110 up through these devices 94, producing the World's first push-pull wind power system 94 ever conceived, with some of the highest efficiencies ever realized. It is understood that since all of the energy 110 to operate any wind powered device 94 mounted at the top and/or roofline (shown but not numbered) of the structure 90, comes from within the structure 90; these wind powered devices 94 are to be considered as mounted within structure 90. Additionally, with the extended walls 92 often called parapets 92 surrounding the top of said structure 90 and extending approximately as high as a top of said wind powered device 94; further support is added to the fact that these wind powered devices 94 are to be considered as mounted within structure 90.

This type of wind energy structure 90 could withstand 150 mph+ winds 100, with the implementation of properly sized and located weather resistant pressure relief valves 26. No sealed surfaces are needed for this type of structure 90 to withstand hurricanes and/or tornadoes and it is strong enough to withstand even stronger winds 100 and continue to produce electrical power throughout any high wind 100 event, through the implementation of properly designed wind energy structures 90 and high speed wind powered devices 94 along with properly sized and located weather resistant pressure relief valves 26, in sufficient numbers. Any form, number, type, shape and/or size of machine device 120 including electrical generator machine devices 122 could be directly connected and/or through belts (not shown), drive lines (not shown) and/or the like (not shown) with any wind powered device 94 that is located within the wind energy structure 90 as shown, in any scheme, occurrence, method and/or apparatus imaginable. Also, any form, number, type, size and/or shape of machine device 120, including electrical generator machine devices 122 could be mounted outside 32 of the wind energy structure 90 as shown and connected with the wind powered devices 94 located within the structure 90 through belts (not shown), drive lines (not shown) and/or the like (not shown). So while all the wind power 94 is created within the structure 90, the force, motion and/or energy generated can be transmitted to the outside 32 of structure 90 and utilized in any scheme, occurrence, method and/or apparatus 120 and/or 122 imaginable.

The description of the present embodiments of the invention has been presented for the purposes of illustration, but is not intended to be exhaustive or to limit the invention to the form disclosed. Many modifications, adaptations and variations will be apparent to those of ordinary skill in the art. As such, the present invention has been disclosed in connection with the preferred embodiments which fall within the spirit and scope of the invention as defined by the following claims.

What is claimed is:

1) A method for utilizing wind energy within a structure comprising:
a. providing a structure with at least one external surface and at least one internal surface within an internal area that has at least one external surface separating said internal area from an outside;
b. providing at least one pressure relief valve in said at least one external surface of said internal area of said structure;
c. wherein said at least one pressure relief valve connects said internal area with said outside;
d. wherein said at least one pressure relief valve allows said wind energy that enters into said internal area through leaks in said structure to pass from said internal area into said outside;
e. wherein said at least one pressure relief valve is adjustable to be set to open at a predetermined internal pressure;
f. wherein said at least one pressure relief valve once set does not require any external influence or assistance to function; and
g. setting said at least one pressure relief valve at a desired internal pressure to open.

2) The method of claim 1 further including providing at least one pressure transfer opening in said at least one external surface of said structure such that said at least one pressure transfer opening allows said wind energy to pass through said at least one external surface of said structure.

3) The method of claim 1 further including:
a. providing at least one additional pressure relief valve in said at least one internal surface within said internal area within said structure;
b. wherein said at least one additional pressure relief valve allows said wind energy that enters into said internal area through leaks in said structure to move through said at least one internal surface within said internal area within said structure;
c. wherein said at least one additional pressure relief valve is adjustable to be set to open at a predetermined internal pressure within said structure;
d. wherein said at least one additional pressure relief valve once set does not require any external influence or assistance to function; and
e. setting said at least one additional pressure relief valve a at desired internal pressure to open.

4) The method of claim 1 further including providing at least one pressure transfer opening in said at least one internal surface within said internal area within said structure such that said wind energy that enters into said internal area through leaks in said structure moves through said at least one internal surface within said internal area within said structure.

5) The method of claim 1 further comprising:
a. more than one room with at least one surface within said internal area within said structure;
b. providing at least one additional pressure relief valve in said at least one surface of said more than one room within said internal area within said structure;
c. wherein said at least one additional pressure relief valve allows said wind energy that enters into said internal area through leaks in said structure to pass through said at least one surface of said more than one room within said internal area within said structure;
d. wherein said at least one additional pressure relief valve is adjustable to be set to open at a predetermined internal pressure within said structure;
e. wherein said at least one additional pressure relief valve once set does not require any external influence or assistance to function; and
f. setting said at least one additional pressure relief valve at a desired internal pressure to open.

6) The method of claim 5 further including providing at least one pressure transfer opening in said at least one surface of said more than one room within said internal area within said structure such that said at least one pressure transfer opening allows said wind energy that enters into said internal area through leaks in said structure to pass through said at least one surface of said more than one room within said internal area within said structure.

7) A method for utilizing wind energy within a structure comprising:
a. providing a structure with an internal area with at least one external surface separating said internal area from an outside;
b. providing at least one channel in said at least one external surface of said internal area of said structure;
c. wherein said at least one channel connects said internal area within said structure with said outside; and
d. wherein said at least one channel allows wind energy to pass between said outside and said internal area within said structure.

8) The method of claim 7 further including:
a. wherein said at least one channel is adjustable to open at a predetermined set point such that said wind energy is allowed to pass from said outside to said internal area within said structure; and
b. setting said at least one channel at a predetermined set point to open.

9) The method of claim 7 further including:
a. wherein said at least one channel is adjustable to close at a predetermined set point such that said wind energy is not allowed to pass between said internal area within said structure and said outside; and
b. setting said at least one channel at a predetermined set point to close.

10) The method of claim 7 further including:
a. wherein said at least one channel is adjustable to open at a predetermined set point such that said wind energy that enters said internal area is allowed to pass from said internal area within said structure to said outside; and
b. setting said at least one channel at a predetermined set point to open.

11) The method of claim 7 further including providing at least one additional said channel in said external surface of said internal area of said structure.

12) The method of claim 7 further including providing at least one additional channel within said internal area within said structure such that said wind energy that enters said internal area is allowed to pass through said at least one additional channel within said internal area within said structure.

13) The method of claim 12 further including:
a. wherein said at least one additional channel is adjustable to close at a predetermined set point such that said wind energy that enters said internal area is not allowed to pass through said at least one additional channel within said internal area within said structure; and
b. setting said at least one additional channel at a predetermined set point to close.

14) The method of claim 12 further including:
a. wherein said at least one additional channel is adjustable to open at a predetermined set point such that said wind energy that enters said internal area is allowed to pass through said at least one additional channel within said internal area within said structure; and
b. setting said at least one additional channel at a predetermined set point to open.

15) The method of claim 7 further including:
a. providing at least one pressure relief valve in said external surface of said internal area of said structure;
b. wherein said at least one pressure relief valve connects said internal area with said outside;
c. wherein said at least one pressure relief valve allows said wind energy that enters said internal area to pass from said internal area into said outside;
d. wherein said at least one pressure relief valve is adjustable to be set to open at a predetermined internal pressure;
e. wherein said at least one pressure relief valve once set does not require any external influence or assistance to function; and
f. setting said at least one pressure relief valve at a desired internal pressure to open.

16) The method of claim 7 further including providing at least one wind powered device within said structure such that said wind energy that enters said internal area moves through said wind powered device.

17) The method of claim 16 wherein said at least one wind powered device is a wind powered electrical generator within said structure.

18) The method of claim 16 further including providing at least one machine device within said structure wherein said at least one wind powered device is connected with said at least one machine device.

19) The method of claim 18 wherein said at least one machine device is an electrical generator.

20) The method of claim 16 further including providing at least one machine device outside said structure wherein said at least one wind powered device is connected with said at least one machine device.

21) The method of claim 20 wherein said at least one machine device is an electrical generator.

22) The method of claim 16 further including a wall surrounding the top of said structure wherein said wall extends approximately as high as a top of said wind powered device.

23) An apparatus for utilizing wind energy within a structure comprising:
a. a structure with at least one external surface and at least one internal surface within an internal area that has at least one external surface separating said internal area from an outside; and
b. at least one pressure relief valve in said at least one external surface of said internal area of said structure;
c. wherein said at least one pressure relief valve connects said internal area within said structure with said outside;
d. wherein said at least one pressure relief valve allows said wind energy that enters into said internal area through leaks in said structure to pass from said internal area within said structure into said outside;
e. wherein said at least one pressure relief valve is adjustable to be set to open at a predetermined internal pressure within said structure; and
f. wherein said at least one pressure relief valve once set does not require any external influence or assistance to function at said predetermined open set point.

24) The apparatus of claim 23 further including at least one pressure transfer opening in said at least one external surface of said structure such that said at least one pressure transfer opening allows said wind energy to pass through said external surface of said structure.

25) The apparatus of claim 23 further including:
a. at least one additional pressure relief valve in said at least one internal surface within said internal area within said structure;
b. wherein said at least one additional pressure relief valve allows said wind energy that enters into said internal area through leaks in said structure to move through said at least one internal surface within said internal area within said structure;
c. wherein said at least one additional pressure relief valve is adjustable to be set to open at a predetermined internal pressure within said structure; and
d. wherein said at least one additional pressure relief valve once set does not require any external influence or assistance to function at said predetermined open set point.

26) The apparatus of claim 23 further including at least one pressure transfer opening in said at least one internal surface within said internal area within said structure such that said wind energy that enters into said internal area through leaks in said structure moves through said at least one internal surface within said internal area within said structure.

27) The apparatus of claim 23 further including:
a. more than one room with at least one surface within said internal area within said structure; and
b. at least one additional pressure relief valve in said at least one surface of said more than one more room within said internal area within said structure;
c. wherein said at least one additional pressure relief valve allows said wind energy that enters into said internal area through leaks in said structure to pass through said at least one surface of said more than one room within said internal area within said structure;
d. wherein said at least one additional pressure relief valve is adjustable to be set to open at a predetermined internal pressure within said structure; and
e. wherein said at least one additional pressure relief valve once set does not require any external influence or assistance to function at said predetermined open set point.

28) The apparatus of claim 27 further including at least one pressure transfer opening in said at least one surface of said more than one room within said internal area within said structure such that said at least one pressure transfer opening allows said wind energy that enters into said internal area through leaks in said structure to pass through said at least one surface of said more than one room within said internal area within said structure.

29) An apparatus for utilizing wind energy within a structure comprising:
a. a structure with an internal area with at least one external surface separating said internal area from an outside;
b. at least one channel in said at least one external surface of said internal area of said structure;
c. wherein said at least one channel connects said internal area within said structure with said outside; and
d. wherein said at least one channel allows said wind energy to pass between said outside and said internal area within said structure.

30) The apparatus of claim 29 wherein said at least one channel is adjustable to open at a predetermined set point such that said wind energy is allowed to pass from said outside to said internal area within said structure at said predetermined open set point.

31) The apparatus of claim 29 wherein said at least one channel is adjustable to close at a predetermined set point such that said wind energy is not allowed to pass between said internal area within said structure and said outside at said predetermined close set point.

32) The apparatus of claim 29 wherein said at least one channel is adjustable to open at a predetermined set point such that said wind energy that enters said internal area is allowed to pass from said internal area within said structure to said outside at said predetermined open set point.

33) The apparatus of claim 29 further including at least one additional said channel in said at least one external surface of said internal area of said structure.

34) The apparatus of claim 29 further including:
a. at least one additional channel in said internal area within said structure; and
b. wherein said wind energy that enters said internal area is allowed to pass through said at least one additional channel within said internal area within said structure.

35) The apparatus of claim 34 wherein said at least one additional channel is adjustable to close at a predetermined set point such that said wind energy that enters said internal area is not allowed to pass through said at least one additional channel within said internal area within said structure at said predetermined close set point.

36) The apparatus of claim 34 wherein said at least one additional channel is adjustable to open at a predetermined set point such that said wind energy that enters said internal area is allowed to pass through said at least one additional channel within said internal area within said structure at said predetermined open set point.

37) The apparatus of claim 29 further including:
a. at least one pressure relief valve in said external surface of said internal area of said structure;
b. wherein said at least one pressure relief valve connects said internal area within said structure with said outside;
c. wherein said at least one pressure relief valve allows said wind energy that enters said internal area to pass from said internal area within said structure into said outside;
d. wherein said at least one pressure relief valve is adjustable to be set to open at a predetermined internal pressure within said structure; and
e. wherein said at least one pressure relief valve once set does not require any external influence or assistance to function at said predetermined open set point.

38) The apparatus of claim 29 further including at least one wind powered device within said structure so that said wind energy that enters said internal area moves through said wind powered device.

39) The apparatus of claim 38 wherein said at least one wind powered device is a wind powered electrical generator within said structure.

40) The apparatus of claim 38 further including at least one machine device within said structure wherein said at least one wind powered device is connected with said at least one machine device.

41) The apparatus of claim 40 wherein said at least one machine device is an electrical generator.

42) The apparatus of claim 38 further including at least one machine device outside said structure wherein said at least one wind powered device is connected with said at least one machine device.

43) The apparatus of claim 42 wherein said at least one machine device is an electrical generator.

44) The apparatus of claim 38 further including a wall at the top of said structure wherein said wall extends approximately as high as a top of said wind powered device.
